(19) United States
(12) Patent Application Publication
(10) Pub. No.: US 2022/0150552 A1
(43) Pub. Date: May 12, 2022

(54) INFORMATION PROCESSING APPARATUS, INFORMATION PROCESSING METHOD, REPRODUCTION PROCESSING DEVICE, AND REPRODUCTION PROCESSING METHOD

(71) Applicant: Sony Group Corporation, Tokyo (JP)

(72) Inventors: Yasuaki YAMAGISHI, Tokyo (JP); Kazuhiko TAKABAYASHI, Tokyo (JP)

(73) Assignee: Sony Group Corporation, Tokyo (JP)

(21) Appl. No.: 17/438,467

(22) PCT Filed: Jan. 31, 2020
(86) PCT No.: PCT/JP2020/003742

§ 371 Date: Sep. 13, 2021

Related U.S. Application Data
(60) Provisional application No. 62/821,027, filed on Mar. 20, 2019.

(51) Int. Cl. H04N 21/235; H04N 21/84; H04N 21/854; H04L 65/60

(52) U.S. Cl. CPC H04N 21/235; H04N 21/84; H04L 65/607; H04L 65/602; H04N 21/854

(57) ABSTRACT

An information processing apparatus and method, and a reproduction processing device and method alleviate processing load at the time of providing content. An MPD generation unit generates an MPD of an image divided by unit area. A metadata generation unit generates viewport rings by, based on an MPD and viewport information indicating a line-of-sight direction for each of priorities determined in advance corresponding to a center of a reference line-of-sight direction, grouping AdaptationSets corresponding to a predetermined area of each of the priorities designated by each piece of the viewport information and grouping AdaptationSets corresponding to each surrounding area of the predetermined area determined by the unit area, generates a viewport ring group by grouping the viewport rings on the basis of the center of the reference line-of-sight direction, and generates a viewport ring group list by listing information regarding a plurality of the viewport ring groups.

### TECHNICAL FIELD

The present invention relates to an information processing apparatus, an information processing method, a reproduction processing device, and a reproduction processing method.

### BACKGROUND ART

In recent years, there is a concern about an increase in processing load on cloud due to streaming viewing on mobile devices that has become widespread in a rapid pace. In response to such a concern, as one of measures to mitigate the processing load on the cloud, attention is focused on distribution of the load of streaming services by using edge computing with networks, computation, storage resources, and the like distributed and arranged at the edge of the network. An edge server that executes edge computing acquires data from an origin server as an information provider arranged in a central cloud in a central part of the cloud in response to a request from a client device and provides the data to the client device.

Here, there is a restriction that various resources of an individual edge server in edge computing are smaller than those of the central cloud in the central part of the cloud. Therefore, there is a possibility that arrangement, selection, and the like of resources become complicated, which causes an increase in management costs. Thus, as high-definition content such as so-called 4K and 8K, as well as streaming services for spherical high-definition content, becomes more widespread in future, it is required to build a mechanism for efficient operation of various resources and efficient utilization of transmission bands in such edge computing.

Based on such requests, discussions have been held on how to provide content data such as virtual reality (VR) streaming in transmission that takes into consideration a reduction of unnecessary data acquisition and optimization of viewports. On the basis of such discussions, technologies for preparing and providing data in smaller units have been proposed for the purpose of improving VR streaming experience.

For example, for the purpose of improving viewport image quality, pieces of data optimized for as many viewports as possible at the same time are prepared. For example, for a viewpoint area of +/−105 degrees in a horizontal direction and +/−90 degrees in a vertical direction, 5×5 unit view ports of +/−65 degrees in the horizontal direction and +/−50 degrees in the vertical direction in which a line-of-sight direction is gradually shifted are prepared for smooth viewport transition.

### CITATION LIST

### Non-Patent Document

Non-Patent Document 1: “ISO/IEC 23090-2”, Working Draft 4—information technology—Coded representation of immersive media—Part 2: Omnidirectional media format
Non-Patent Document 2: “ISO/IEC 23009-1”, information technology—Dynamic adaptive streaming over HTTP (DASH)—Part 1: Media presentation description and formats

### SUMMARY OF THE INVENTION

### Problems to be Solved by the Invention

However, in a case where viewports are finely set as described above, selecting data to be acquired only from data corresponding to a viewport requested from a client device is cumbersome and difficult processing for a server at the edge. Then, in a case where each piece of subdivided data is acquired individually, a large number of acquisition requests are generated, which increases processing overhead.

It is therefore an object of the present disclosure to provide an information processing apparatus, an information processing method, a reproduction processing device, and a reproduction processing method that alleviate processing load at the time of providing content.

### Solutions to Problems

According to the present disclosure, a media presentation description (MPD) generation unit generates an MPD of an image divided by unit area. A metadata generation unit generates each of viewport rings by, on the basis of the MPD generated by the MPD generation unit and viewport information indicating a line-of-sight direction for each of priorities determined in advance corresponding to a center of a reference line-of-sight direction, grouping AdaptationSets corresponding to a predetermined area of each of the priorities designated by each piece of the viewport information and grouping AdaptationSets corresponding to each surrounding area of the predetermined area determined by the unit area, generates a viewport ring group by grouping the viewport rings on the basis of the center of the reference line-of-sight direction, and generates a viewport ring group list by listing information regarding a plurality of the viewport ring groups.

### BRIEF DESCRIPTION OF DRAWINGS

FIG. 1 is a system configuration diagram of an example of a distribution system.

FIG. 2 is a diagram for illustrating an example of a spherical image.

FIG. 3 is a diagram illustrating a viewport ring group of one importance level.

FIG. 4 is a diagram illustrating a viewport ring group of two importance levels.

FIG. 5 is a diagram illustrating a viewport ring group of three importance levels.

FIG. 6 is a diagram for illustrating a case where viewport rings of three importance levels are represented by using differences.

FIG. 7 is a diagram illustrating an example of syntax in a case where a viewport ring group constituted by viewport rings of three importance levels is represented by using differences.

FIG. 8 is a diagram illustrating an example of syntax in a case where a viewport ring group including viewport rings on the left side of two importance levels is represented by using differences.

FIG. 9 is a diagram illustrating an example of syntax in a case where a viewport ring group including viewport rings on the right side of two importance levels is represented by using differences.

FIG. 10 is a diagram illustrating an example of syntax in a case where a viewport ring group including viewport rings on the left side, center, and right side of two importance levels is represented by using differences.

FIG. 11 is a diagram illustrating a case where boundaries of coverages cannot be expressed as integral multiples of a constant angle.

FIG. 12 is a diagram illustrating an example of syntax indicating a viewport ring group in a case where boundaries of coverages cannot be expressed as integral multiples of a constant angle.

FIG. 13 is a diagram illustrating a case where boundaries of coverages can be expressed as integral multiples of a constant angle.

FIG. 14 is a diagram illustrating an example of syntax indicating a viewport ring group in a case where boundaries of coverages can be expressed as integral multiples of a constant angle.

FIG. 15 is a sequence diagram of content distribution processing using viewport rings according to a first embodiment.

FIG. 16 is a sequence diagram of content distribution processing using viewport rings according to a second embodiment.

FIG. 17 is a sequence diagram illustrating segment data acquisition processing according to a third embodiment.

FIG. 18 is a diagram illustrating an example of a response to a segment dataset request according to the third embodiment.

FIG. 19 is a sequence diagram illustrating segment data acquisition processing according to a modified example (1) of the third embodiment.

FIG. 20 is a sequence diagram illustrating segment data acquisition processing according to a modified example (2) of the third embodiment.

FIG. 21 is a sequence diagram illustrating segment data acquisition processing according to a modified example (3) of the third embodiment.

FIG. 22 is a sequence diagram of content distribution processing using viewport rings according to the third embodiment and each modified example of the third embodiment.

### MODE FOR CARRYING OUT THE INVENTION

Hereinafter, embodiments of the present disclosure will be described in detail with reference to the drawings. Note that, in each of the following embodiments, the same portions are denoted by the same reference numerals, and duplicate description will be omitted. Note that the scope disclosed in the present technology is not limited to the contents of the embodiments but also includes the contents described in the following non-patent documents known at the time of filing.

Non-Patent Document 1: (described above)

Non-Patent Document 2: (described above)

Non-Patent Document 3: “ISO/IEC 14496-12:2015”, Information technology. Coding of audio-visual object, Part 12

Non-Patent Document 4: “ISO/IEC 23090-8”, Working Draft 4—information technology—Coded representation of immersive media—Part 8: Interfaces for network media processing

The contents described in the non-patent documents described above are also incorporated herein by reference. That is, the contents described in the non-patent documents described above are also the basis for determining support requirements. For example, even in a case where terms used in “File Structure” described in Non-Patent Document 1 and the MPEG-DASH standard described in Non-Patent Document 2 are not directly described in the detailed description of the invention, such terms are also included in the scope of disclosure of the present technology, and meet support requirements of the claims. Furthermore, in a similar manner, even in a case where technical terms such as parsing, syntax, and semantics are not directly described in the detailed description of the invention, such technical terms are also included in the scope of disclosure of the present technology, and meet the support requirements of the claims.

Furthermore, the present disclosure will be described in the order of items described below.

1. First Embodiment

2. Second Embodiment

3. Third Embodiment
3.1 Modified example (1) of third embodiment
3.2 Modified example (2) of third embodiment
3.3 Modified example (3) of third embodiment

### 1. First Embodiment

An origin server generates segment data and media presentation description (MPD) files for distributing video content data such as 6DoF content. Segment data is a file in which content is divided by a unit of time. An MPD file stores an AdaptationSet that contains a media type, reproduction time of segment data of a moving image and sounds, address information, and the like. In a case of viewing of streaming or the like, a client device sends a sending request for content to be used. Thereafter, an MPD file is sent to the client device. The client device analyzes the MPD file, selects a stream of the content to be used, and makes an acquisition request. One stream contains a plurality of AdaptationSets used when the stream is reproduced.

For the purpose of improving viewport image quality, pieces of data optimized for as many viewports as possible at the same time are prepared. Moreover, one viewport may be constituted by one AdaptationSet. However, in that case, it is difficult to preferentially acquire and render data of a minimum area with a fine granularity. Thus, it is often the case that one viewport is constituted by as many AdaptationSets as possible. Therefore, there is a possibility that as the number of viewports increases, the number of AdaptationSets increases exponentially.

In such an environment, in a case where data corresponding to a specific viewport is acquired from an upstream, the client device parses a huge number of AdaptatinSets in an MPD and then sends a request to an edge server to acquire data corresponding to a large number of AdaptationSets from the origin server. In this way, processing performed by the client device becomes cumbersome, and there is a possibility that an overhead in content acquisition processing may increase.

Furthermore, in order to promptly respond to a request from the client device, the edge server executes prefetch in which data corresponding to a viewport designated by the client device is acquired in advance from the origin server. However, in a case where prefetch is executed, the edge server parses a huge number of AdaptationSets in an individual MPD processed by a subordinate group of client devices, and then acquires, from the origin server, data corresponding to viewport information from the client device. In this way, also in the edge server, the processing becomes cumbersome in a similar manner, and there is a possibility that the overhead in the content acquisition processing may increase.

Moreover, reducing unnecessary data as much as possible when sending a request requires the client device to send an acquisition request for each of AdaptationSets corresponding to pieces of data obtained by subdividing content data. Therefore, there is a possibility that the overhead in the content acquisition processing may further increase.

[System Configuration According to First Embodiment]

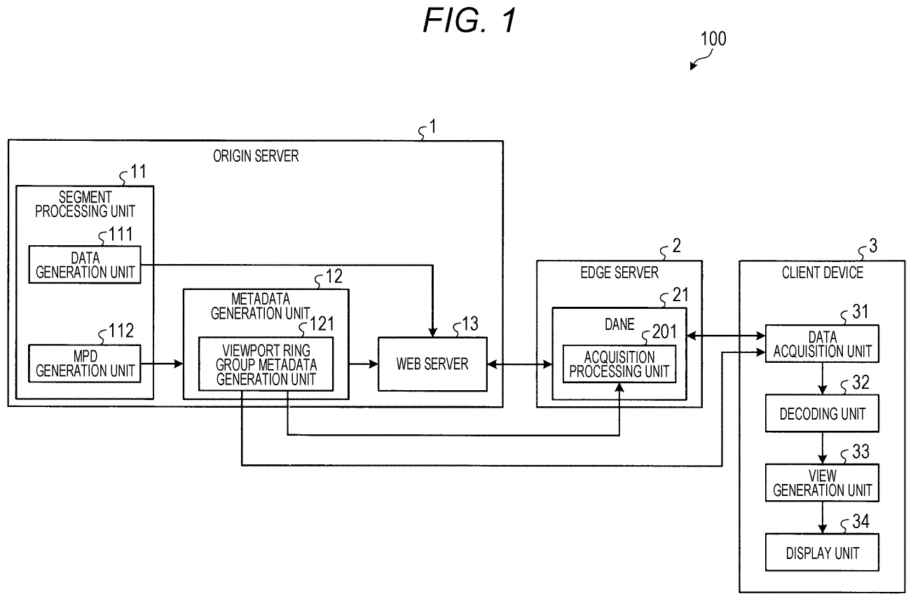

FIG. 1 is a system configuration diagram of an example of a distribution system. A distribution system 100 includes an origin server 1, an edge server 2, and a client device 3. The origin server 1 and the edge server 2 are connected via a core network, which is a first network. The client device 3 and the edge server 2 are connected by a second network such as a local network.

The origin server 1 generates segment data of video content and an MPD file. Moreover, the origin server 1 generates metadata for reproducing the content, and adds the metadata to the MPD file. This metadata contains viewport group metadata for identification of a group of viewports. Then, the origin server 1 stores a segment file and the MPD file in a state in which the edge server 2 can access them.

The edge server 2 caches MPD files that are likely to be used by the client device 3. Thereafter, the edge server 2 receives a content acquisition request from the client device 3, and sends an MPD file of the designated content to the client device 3. At this time, if the MPD file to be provided has been cached in the edge server 2, the edge server 2 provides the MPD file. If the MPD file has not been cached, the edge server 2 sends an acquisition request to the origin server to acquire the MPD file to be used, and provides the MPD file to the client device 3. Thereafter, the edge server 2 receives, from the client device 3, viewport metrics in accordance with a viewpoint movement, and identifies segment data that is likely to be used in accordance with the acquired view metrics. Then, the edge server 2 acquires the identified segment data from the origin server 1, and prefetches the segment data. Thereafter, the edge server 2 receives a segment data acquisition request from the client device 3, and sends the requested segment data to the client device 3.

The client device 3 sends, to the edge server 2, a request to acquire 6DoF content to be used. In response to the request, the client device 3 receives an MPD file from the edge server 2. Thereafter, the client device 3 identifies a stream to be used from the MPD file, and acquires and reproduces spherical segment data by using an AdaptationSet contained in the stream. Thereafter, the client device 3 detects a movement of a line-of-sight, and acquires and reproduces segment data in accordance with the movement of the line of sight.

[Origin Server Configuration]

Next, details of the origin server 1 will be described. As illustrated in FIG. 1, the origin server 1 has a segment processing unit 11, a metadata generation unit 12, and a web server 13.

The segment processing unit 11 has a data generation unit 111 and an MPD generation unit 112. The segment processing unit 11 receives an input of original information for generating content containing a three-dimensional object, meta-information, and the like.

The data generation unit 111 determines a bitstream configuration from the original information, and generates a scene graph by using information regarding access to a bitstream of the content. Then, the data generation unit 111 generates segment data by performing coding processing on the bitstream or a scene description and storing the coded bitstream or scene description in an ISO base media file format (ISOBMFF), for example. Then, the data generation unit 111 uploads the generated segment data to the web server 13.

The MPD generation unit 112 creates an AdaptationSet from the original information on the basis of information regarding a reproduction time of the three-dimensional object and information regarding access to the bitstream, and uses the created AdaptationSet to generate an MPD file. Then, the MPD generation unit 112 outputs the generated MPD file to the metadata generation unit 12.

The metadata generation unit 12 receives an input of the MPD file from the MPD generation unit 112. The metadata generation unit 12 generates metadata such as information regarding access to the AdaptationSet of each MPD file.

Furthermore, the metadata generation unit 12 has a viewport ring group metadata generation unit 121. The viewport ring group metadata generation unit 121 generates viewport rings and viewport ring group information on the basis of information stored in the MPD files. A viewport ring is information regarding a viewport indicating a line-of-sight direction (viewport) set in advance and AdaptationSet groups corresponding to one for each of areas surrounding the line-of-sight direction (viewport). Furthermore, a viewport ring group is information containing a collection of viewports that are layered so that the area expands from the center of each viewport to the surrounding. Then, the metadata generation unit 12 generates a viewport ring group list in which information regarding the viewport ring and the viewport ring group is listed.

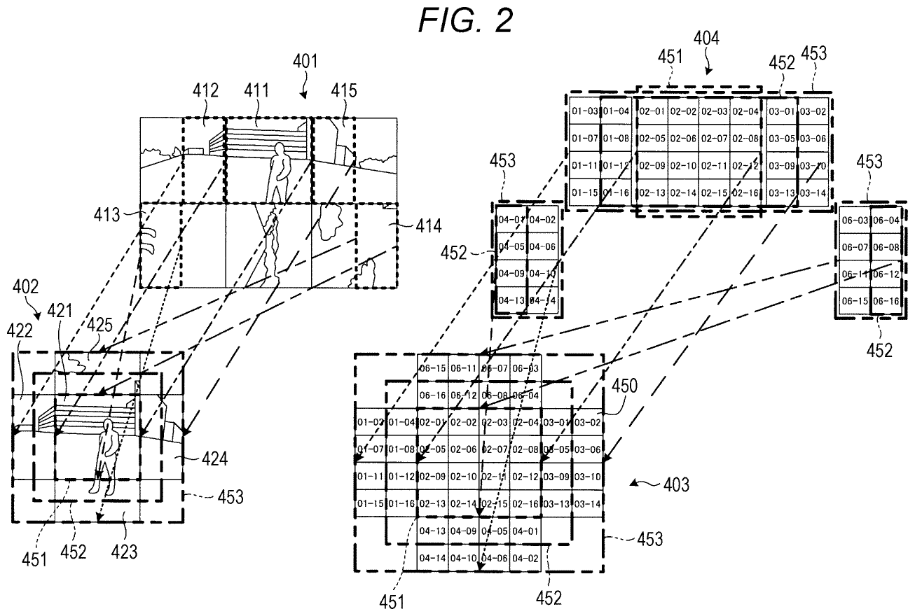

Details of the viewport ring and the viewport ring group will be described below. FIG. 2 is a diagram for illustrating an example of a spherical image.

A spherical image 401 corresponds to a video transferred to each surface of a cubic space surrounding the center, and is a video obtained by dividing the video viewed from the center into six parts. In the spherical image 401, an image 411 in the upper center of paper corresponds to the image in the line-of-sight direction. Then, a line-of-sight direction image 402 is an image including the image 411 in the line-of-sight direction and a range of 90 degrees around the image 411 in the spherical image 401. The center of the viewport of the line-of-sight direction image 402 corresponds to an example of the “center of a reference line-of-sight direction”.

Arrows extending from the spherical image 401 to the line-of-sight direction image 402 represent the corresponding sides. The image 411 is an image including the center of the viewport, and corresponds to an image 421. An image 412 is an image up to 90 degrees to the left, and corresponds to an image 422. An image 413 is an image up to 90 degrees downward, and corresponds to an image 423. An image 414 is an image up to 90 degrees upward, and corresponds to an image 425. An image 415 is an image up to 90 degrees to the right, and corresponds to an image 424.

In the line-of-sight direction image 402, areas 451 to 453 in accordance with importance are assigned in advance. The area 451 surrounded by a broken line is an area in proximity to the center of the viewport, and is an area of high importance. The area 452 surrounded by an alternate long and short dash line is an area of medium importance some distance away from the center of the viewport. The area 453 surrounded by an alternate long and two short dashes line is an area of low importance that is far from the center of the viewport and close to a limit of a field of view. Information indicating the areas 451 to 453 in accordance with importance corresponds to an example of “viewport information”.

The spherical image 401 is divided into tiles 450, which are unit areas, and is represented in cube map format. A tile arrangement 403 represents a state of arrangement of each of the tiles 450 in a case where the line-of-sight direction image 402 is divided by the tiles 450. In the line-of-sight direction image 402, the tiles 450 included in each of the areas 451 to 453 are visible.

A tile arrangement 404 is an image showing where each of the tiles 450 included in the line-of-sight direction image 402 is arranged in a case where the spherical image 401 is divided into tiles. Each of the tiles 450 in the tile arrangement 403 and the tile arrangement 404 is numbered, and tiles 450 with the same number represent the same tile 450. Images transferred to areas of the tiles 450 are called subpictures. An image in one tile 450 is represented by one AdaptationSet. In the following, a viewport ring will be described using the image in FIG. 2 as an example.

First, a case where a viewport ring group is constituted by viewport rings of one importance level will be described. In a case where it is not necessary to classify viewport rings into levels, the viewport ring group metadata generation unit 121 uses a viewport ring group constituted by one importance level.

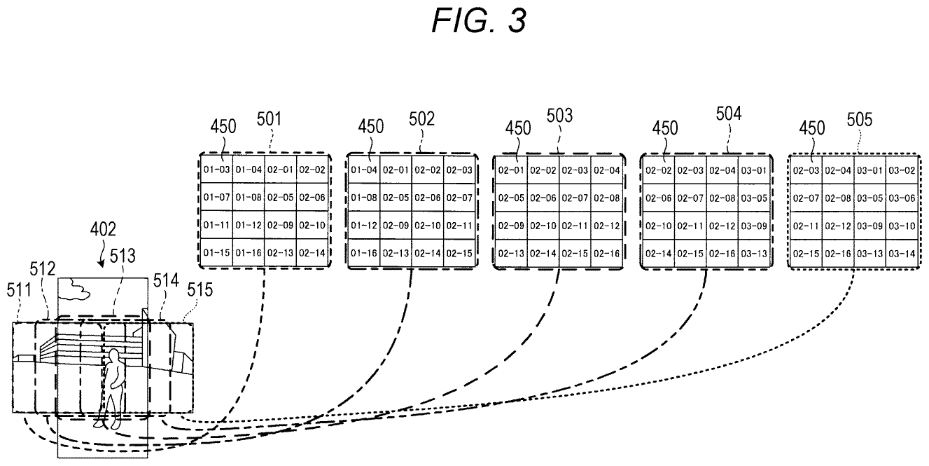

In this case, the viewport ring group metadata generation unit 121 generates a viewport ring in accordance with a change in line-of-sight angle for an area of high importance. The viewport ring group metadata generation unit 121 generates a viewport ring for a surrounding area determined by the unit area with respect to the area of high importance centered on the center of the viewport. FIG. 3 is a diagram illustrating a viewport ring group of one importance level. For example, the viewport ring group metadata generation unit 121 generates viewport rings 501 to 505 illustrated in FIG. 3.

The viewport ring 503 is information containing a collection of AdaptationSets representing the tiles 450 in the range of 45 degrees up and down and 45 degrees left and right from the center of the viewport of the line-of-sight direction image 402. That is, the viewport ring 503 represents a set of AdaptationSets of the tiles 450 included in the area of high importance in the line-of-sight direction image 402. The tiles 450 included in the viewport ring 503 represents an image corresponding to an image 513 in the line-of-sight direction image 402.

The viewport ring 502 is information containing a collection of AdaptationSets representing the tiles 450 in the range of 45 degrees up and down from the center of the viewport in the line-of-sight direction image 402 and the range from a position moved 63.5 degrees to the left to a position moved 26.5 degrees to the right. That is, the viewport ring 502 represents a set of AdaptationSets of the tiles 450 included in the area of high importance in a case where the center of the viewport is in a direction shifted by 26.5 degrees to the left from the center of the viewport in the line-of-sight direction image 402. The tiles 450 included in the viewport ring 502 represents an image corresponding to an image 512 in the line-of-sight direction image 402.

The viewport ring 501 is information containing a collection of AdaptationSets representing the tiles 450 in the range of 45 degrees up and down from the center of the viewport in the line-of-sight direction image 402 and the range from a position moved 90 degrees to the left to a position moved 0 degrees to the right. That is, the viewport ring 501 represents a set of AdaptationSets of the tiles 450 included in the area of high importance in a case where the center of the viewport is in a direction shifted by 45 degrees to the left from the center of the viewport in the line-of-sight direction image 402. The tiles 450 included in the viewport ring 501 represents an image corresponding to an image 511 in the line-of-sight direction image 402.

The viewport ring 504 is information containing a collection of AdaptationSets representing the tiles 450 in the range of 45 degrees up and down from the center of the viewport in the line-of-sight direction image 402 and the range from a position moved 26.5 degrees to the left to a position moved 63.5 degrees to the right. That is, the viewport ring 502 represents a set of AdaptationSets of the tiles 450 included in the area of high importance in a case where the center of the viewport is in a direction shifted by 26.5 degrees to the right from the center of the viewport in the line-of-sight direction image 402. The tiles 450 included in the viewport ring 504 represents an image corresponding to an image 514 in the line-of-sight direction image 402.

The viewport ring 505 is information containing a collection of AdaptationSets representing the tiles 450 in the range of 45 degrees up and down from the center of the viewport in the line-of-sight direction image 402 and the range from a position moved 0 degrees to the left to a position moved 90 degrees to the right. That is, the viewport ring 501 represents a set of AdaptationSets of the tiles 450 included in the area of high importance in a case where the center of the viewport is in a direction shifted by 45 degrees to the right from the center of the viewport in the line-of-sight direction image 402. The tiles 450 included in the viewport ring 505 represents an image corresponding to an image 515 in the line-of-sight direction image 402.

FIG. 3 illustrates viewport rings in a case where the line-of-sight direction is shifted to the left and right, and the same applies to a case where the line-of-sight direction is shifted upward and downward. Furthermore, the angle by which the center of the viewport is shifted is not limited to this angle.

Next, a case where a viewport ring group is constituted by viewport rings of two importance levels will be described. In a case where viewport rings are weighted and classified into two levels, the viewport ring group metadata generation unit 121 uses a viewport ring group constituted by two importance levels. The viewport ring group metadata generation unit 121 assumes that one level of the viewport rings included in the viewport ring group is more important than the other.

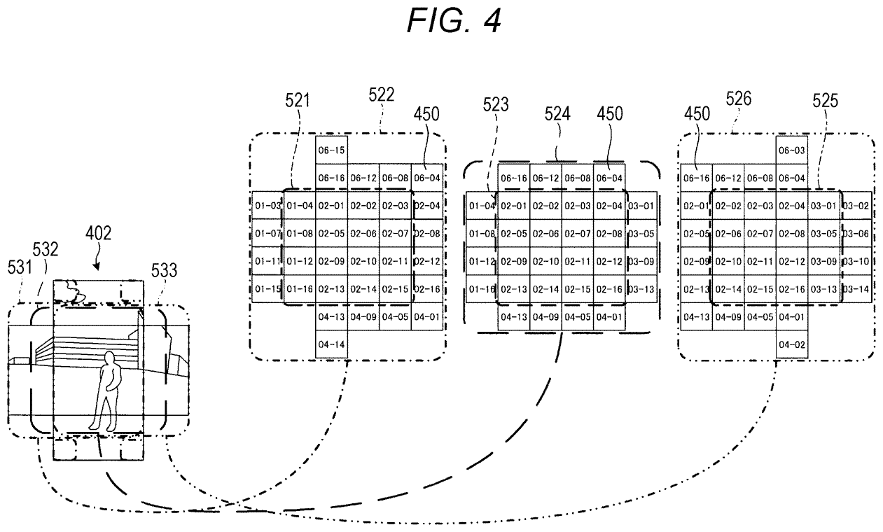

In this case, the viewport ring group metadata generation unit 121 generates viewport rings in accordance with the line-of-sight angle for two areas: an area of high importance and an area of medium importance. FIG. 4 is a diagram illustrating a viewport ring group of two importance levels. For example, the viewport ring group metadata generation unit 121 generates viewport rings 521 to 526 illustrated in FIG. 4.

The viewport ring 523 is information containing a collection of AdaptationSets representing the tiles 450 in the range of 45 degrees up and down and 45 degrees left and right from the center of the viewport of the line-of-sight direction image 402. That is, the viewport ring 523 represents a set of AdaptationSets of the tiles 450 included in the area of high importance in the line-of-sight direction image 402.

Furthermore, the viewport ring 524 is information containing a collection of AdaptationSets representing the tiles 450 in the range of 63.5 degrees up and down and 63.5 degrees left and right from the center of the viewport of the line-of-sight direction image 402. That is, the viewport ring 524 represents a set of

AdaptationSets of the tiles 450 included in the area of medium importance in the line-of-sight direction image 402. The tiles 450 included in the viewport ring 524 represents an image corresponding to an image 532 in the line-of-sight direction image 402.

The viewport ring 521 is information containing a collection of AdaptationSets representing the tiles 450 in the range of 45 degrees up and down from the center of the viewport in the line-of-sight direction image 402 and the range from a position moved 63.5 degrees to the left to a position moved 26.5 degrees to the right. That is, the viewport ring 521 represents a set of AdaptationSets of the tiles 450 included in the area of high importance in a case where the center of the viewport is in a direction shifted by 26.5 degrees to the left from the center of the viewport in the line-of-sight direction image 402. That is, the viewport ring 521 represents a set of AdaptationSets of the tiles 450 included in the area of high importance in a case where the center of the viewport is in a direction shifted by 26.5 degrees to the left from the center of the viewport in the line-of-sight direction image 402.

Furthermore, the viewport ring 522 is information containing a collection of AdaptationSets representing the tiles 450 in the range of 63.5 degrees up and down from the center of the viewport in the line-of-sight direction image 402 and the range from a position moved 90 degrees to the left to a position moved 45 degrees to the right. That is, the viewport ring 522 represents a set of AdaptationSets of the tiles 450 included in the area of medium importance in a case where the center of the viewport is in a direction shifted by 26.5 degrees to the left from the center of the viewport in the line-of-sight direction image 402. The tiles 450 included in the viewport ring 522 represents an image corresponding to an image 531 in the line-of-sight direction image 402.

The viewport ring 525 is information containing a collection of AdaptationSets representing the tiles 450 in the range of 45 degrees up and down from the center of the viewport in the line-of-sight direction image 402 and the range from a position moved 26.5 degrees to the left to a position moved 63.5 degrees to the right. That is, the viewport ring 525 represents a set of AdaptationSets of the tiles 450 included in the area of high importance in a case where the center of the viewport is in a direction shifted by 26.5 degrees to the right from the center of the viewport in the line-of-sight direction image 402.

Furthermore, the viewport ring 526 is information containing a collection of AdaptationSets representing the tiles 450 in the range of 63.5 degrees up and down from the center of the viewport in the line-of-sight direction image 402 and the range from a position moved 45 degrees to the left to a position moved 90 degrees to the right. That is, the viewport ring 526 represents a set of AdaptationSets of the tiles 450 included in the area of medium importance in a case where the center of the viewport is in a direction shifted by 26.5 degrees to the right from the center of the viewport in the line-of-sight direction image 402. The tiles 450 included in the viewport ring 526 represents an image corresponding to an image 533 in the line-of-sight direction image 402.

Viewport rings of the same level include the same number of tiles 450. That is, the viewport rings 522, 524, and 526 include the same number of tiles 450. FIG. 4 illustrates viewport rings in a case where the line-of-sight direction is shifted to the left and right, and the same applies to a case where the line-of-sight direction is shifted upward and downward. Furthermore, the angle by which the center of the viewport is shifted is not limited to this angle.

Next, a case where a viewport ring group is constituted by viewport rings of three importance levels will be described. In a case where viewport rings are weighted and classified into three levels, the viewport ring group metadata generation unit 121 uses a viewport ring group constituted by three importance levels. The viewport ring group metadata generation unit 121 assigns three different levels of importance one to each of the three levels of viewport rings included in the viewport ring group.

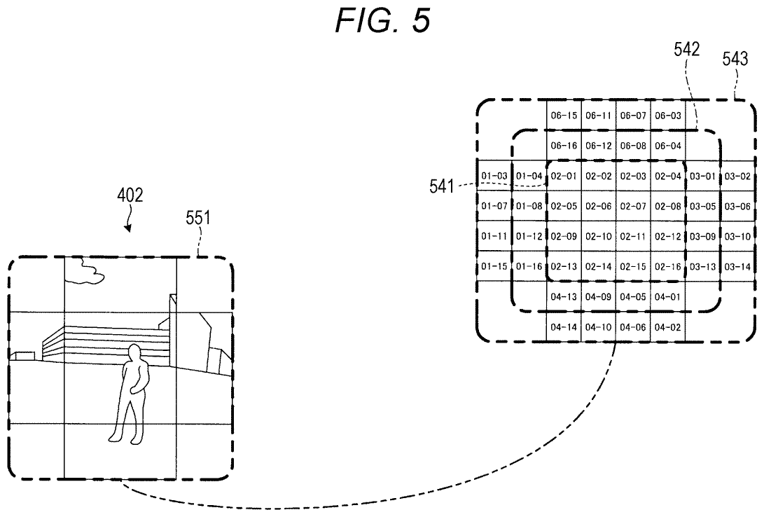

In this case, the viewport ring group metadata generation unit 121 generates viewport rings in accordance with the line-of-sight angle for three areas: an area of high importance, an area of medium importance, and an area of low importance. FIG. 5 is a diagram illustrating a viewport ring group of three importance levels. For example, the viewport ring group metadata generation unit 121 generates viewport rings 541 to 543 illustrated in FIG. 5.

The viewport ring 541 is information containing a collection of AdaptationSets representing the tiles 450 in the range of 45 degrees up and down and 45 degrees left and right from the center of the viewport of the line-of-sight direction image 402. That is, the viewport ring 541 represents a set of AdaptationSets of the tiles 450 included in the area of high importance in the line-of-sight direction image 402.

Furthermore, the viewport ring 542 is information containing a collection of AdaptationSets representing the tiles 450 in the range of 63.5 degrees up and down and 63.5 degrees left and right from the center of the viewport of the line-of-sight direction image 402. That is, the viewport ring 542 represents a set of

AdaptationSets of the tiles 450 included in the area of medium importance in the line-of-sight direction image 402.

Furthermore, the viewport ring 543 is information containing a collection of AdaptationSets representing the tiles 450 in the range of 90 degrees up and down and 90 degrees left and right from the center of the viewport of the line-of-sight direction image 402. That is, the viewport ring 543 represents a set of AdaptationSets of the tiles 450 included in the area of low importance in the line-of-sight direction image 402. The tiles 450 included in the viewport ring 543 represents an image corresponding to an image 551 in the line-of-sight direction image 402.

FIG. 5 illustrates an example of a case where the center of the viewport of the line-of-sight direction image 402 is in the line-of-sight direction, and the viewport ring group metadata generation unit 121 also generates viewport rings in which the line of sight is moved in a similar manner to those in FIGS. 3 and 4.

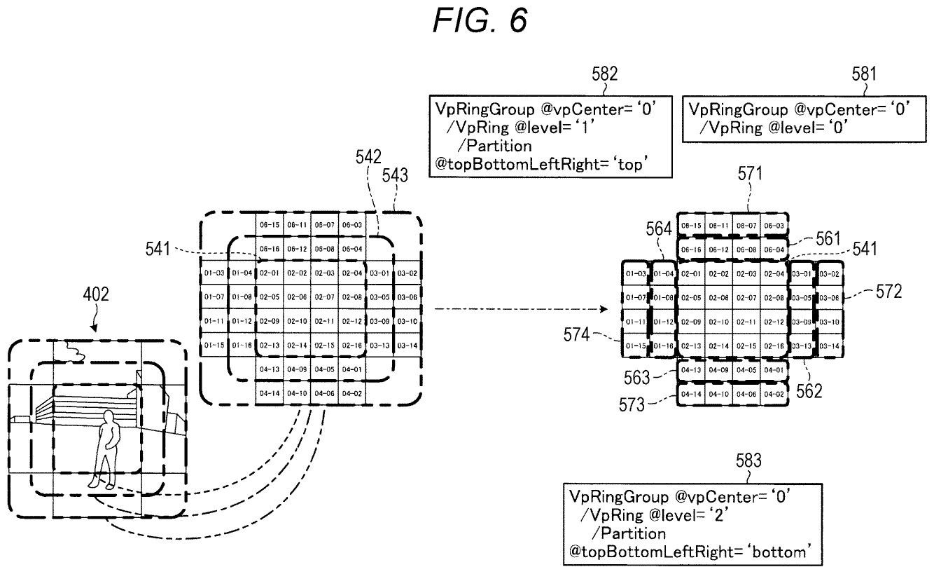

Furthermore, the viewport ring group metadata generation unit 121 may represent every one of the viewport rings of each level by using differences. FIG. 6 is a diagram for illustrating a case where viewport rings of three importance levels are represented by using differences.

In a similar manner to FIG. 5, a case of creating the viewport ring 541 for the area of high importance, the viewport ring 542 for the area of medium importance, and the viewport ring 543 for the area of low importance in the line-of-sight direction image 402 will be described.

In this case, the viewport ring group metadata generation unit 121 includes, for the viewport ring 541, AdaptationSets representing all the tiles 450 included in the area. Next, for the viewport ring 542, the viewport ring group metadata generation unit 121 generates a difference viewport ring 561, which is a difference on the top side with respect to the viewport ring 541. In a similar manner, the viewport ring group metadata generation unit 121 generates a difference viewport ring 562, which is a difference on the right side, a difference viewport ring 563, which is a difference on the bottom side, and a difference viewport ring 564, which is a difference on the left side. Here, top, bottom, left, and right as viewed in a direction facing a plane of paper are used for expression. Then, the viewport ring group metadata generation unit 121 represents the viewport ring 542 by adding the difference viewport rings 561 to 564 to the viewport ring 541.

Furthermore, for the viewport ring 543, the viewport ring group metadata generation unit 121 generates a difference viewport ring 571, which is a difference on the top side with respect to the viewport ring 542. In a similar manner, the viewport ring group metadata generation unit 121 generates a difference viewport ring 572, which is a difference on the right side, a difference viewport ring 573, which is a difference on the bottom side, and a difference viewport ring 574, which is a difference on the left side. Then, the viewport ring group metadata generation unit 121 represents the viewport ring 543 by adding the difference viewport rings 561 to 564 and 571 to 574 to the viewport ring 541.

For example, the viewport ring group metadata generation unit 121 sets high importance to level 0, medium importance to level 1, and low importance to level 2. Then, the viewport ring group metadata generation unit 121 represents the viewport ring 541 together with the importance as in syntax 581. Furthermore, the viewport ring group metadata generation unit 121 represents the difference viewport ring 561, which is a difference on the top side of the viewport ring 542, by using the position and importance with respect to the viewport ring 541, as in syntax 582. Furthermore, the viewport ring group metadata generation unit 121 represents the difference viewport ring 573, which is a difference on the bottom side of the viewport ring 543, by using the position and importance with respect to the viewport ring 541, as in syntax 583.

In this way, the viewport ring group metadata generation unit 121 can represent each of the viewport rings that differ in importance by using differences between the viewport rings. Expressing each of the viewport rings by using the differences makes it possible to avoid duplication of acquisition of AdaptationSets in the client device 3.

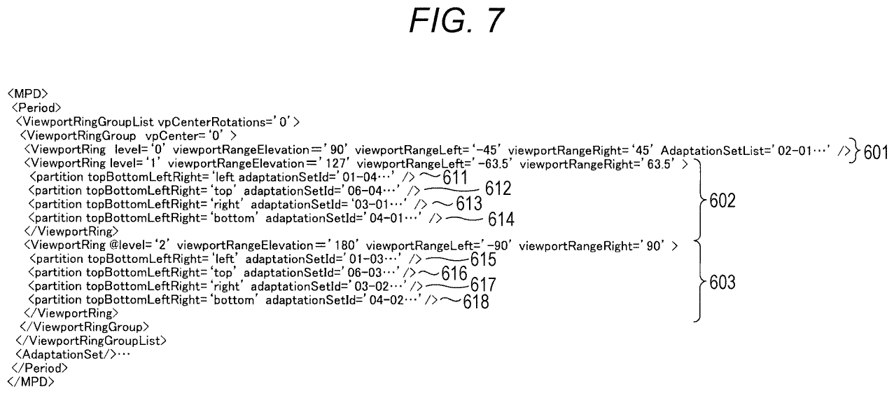

FIG. 7 is a diagram illustrating an example of syntax in a case where a viewport ring group constituted by viewport rings of three importance levels is represented by using differences. The viewport ring group metadata generation unit 121 uses the syntax illustrated in FIG. 7 to generate an MPD file representing a viewport ring group constituted by viewport rings of three importance levels.

A line 601 in FIG. 7 represents a viewport ring of the area of high importance in each of the different line-of-sight directions, including the viewport ring 541 in FIG. 6. Furthermore, a line 602 represents the difference between the area of medium importance and the area of high importance in each of the different line-of-sight directions, including the difference between the viewport ring 542 and the viewport ring 541 in FIG. 6. A line 611 represents a difference viewport ring on the left side with respect to the area of high importance in each of the different line-of-sight directions, including the difference viewport ring 564 in FIG. 6. A line 612 represents a difference viewport ring on the top side with respect to the area of high importance in each of the different line-of-sight directions, including the difference viewport ring 561 in FIG. 6. A line 613 represents a difference viewport ring on the right side with respect to the area of high importance in each of the different line-of-sight directions, including the difference viewport ring 562 in FIG. 6. A line 614 represents a difference viewport ring on the left side with respect to the area of high importance in each of the different line-of-sight directions, including the difference viewport ring 563 in FIG. 6.

Furthermore, a line 603 represents the difference between the area of low importance and the area of medium importance in each of the different line-of-sight directions, including the difference between the viewport ring 543 and the viewport ring 542 in FIG. 6. A line 615 represents a difference viewport ring on the left side with respect to the area of medium importance in each of the different line-of-sight directions, including the difference viewport ring 574 in FIG. 6. A line 616 represents a difference viewport ring on the top side with respect to the area of medium importance in each of the different line-of-sight directions, including the difference viewport ring 571 in FIG. 6. A line 617 represents a difference viewport ring on the right side with respect to the area of medium importance in each of the different line-of-sight directions, including the difference viewport ring 572 in FIG. 6. A line 618 represents a difference viewport ring on the bottom side with respect to the area of medium importance in each of the different line-of-sight directions, including the difference viewport ring 573 in FIG. 6.

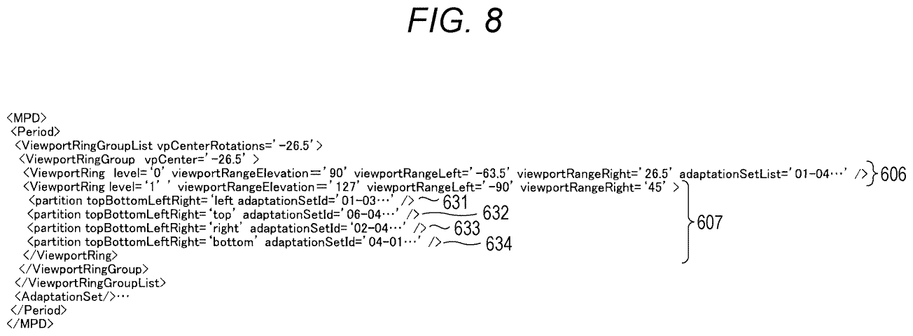

Next, syntax of an MPD file in a case where two importance levels are used will be described. FIG. 8 is a diagram illustrating an example of syntax in a case where a viewport ring group including viewport rings on the left side of two importance levels is represented by using differences. The viewport ring group metadata generation unit 121 uses the syntax illustrated in FIG. 8 to generate an MPD file representing a viewport ring group, which is viewport rings of the two importance levels and includes the viewport ring 522 on the left side in FIG. 4.

A line 606 in FIG. 8 represents a viewport ring of the area of high importance in each of the different line-of-sight directions, including the viewport ring 521 in FIG. 4. Furthermore, a line 607 represents the difference between the area of medium importance and the area of high importance in each of the different line-of-sight directions, including the difference between the viewport ring 521 and the viewport ring 522 in FIG. 4. A line 631 represents a difference viewport ring on the left side with respect to the area of medium importance in each of the different line-of-sight directions, including the tiles 450 with numbers 01-03, 01-07, 01-11, and 01-15 in FIG. 4. A line 632 represents a difference viewport ring on the top side with respect to the area of medium importance in each of the different line-of-sight directions, including numbers 06-04, 06-08, 06-12, 06-15, and 06-16 in FIG. 4. A line 633 represents a difference viewport ring on the right side with respect to the area of medium importance in each of the different line-of-sight directions, including numbers 02-04, 02-08, 02-12, and 02-16 in FIG. 4. A line 634 represents a difference viewport ring on the bottom side with respect to the area of medium importance in each of the different line-of-sight directions, including numbers 04-01, 04-05, 04-09, 04-13, and 04-14 in FIG. 4.

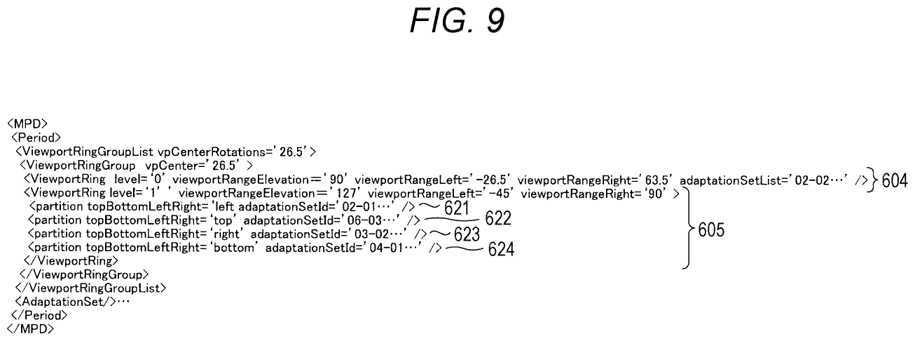

Furthermore, FIG. 9 is a diagram illustrating an example of syntax in a case where a viewport ring group including viewport rings on the right side of two importance levels is represented by using differences. The viewport ring group metadata generation unit 121 uses the syntax illustrated in FIG. 9 to generate an MPD file representing a viewport ring group, which is viewport rings of the two importance levels and includes the viewport ring 526 on the right side in FIG. 4.

A line 604 in FIG. 9 represents a viewport ring of the area of high importance in each of the different line-of-sight directions, including the viewport ring 525 in FIG. 4 Furthermore, a line 605 represents the difference between the area of medium importance and the area of high importance in each of the different line-of-sight directions, including the difference between the viewport ring 526 and the viewport ring 525 in FIG. 4. A line 621 represents a difference viewport ring on the left side with respect to the area of medium importance in each of the different line-of-sight directions, including the tiles 450 with numbers 02-01, 02-05, 02-09, and 02-13 in FIG. 4. A line 622 represents a difference viewport ring on the top side with respect to the area of medium importance in each of the different line-of-sight directions, including numbers 06-03, 06-04, 06-08, 06-12, and 06-16 in FIG. 4. A line 623 represents a difference viewport ring on the right side with respect to the area of medium importance in each of the different line-of-sight directions, including numbers 03-02, 03-06, 03-10, and 03-14 in FIG. 4. A line 624 represents a difference viewport ring on the left side with respect to the area of medium importance in each of the different line-of-sight directions, including numbers 04-01, 04-02, 04-05, 04-09, and 04-13 in FIG. 4.

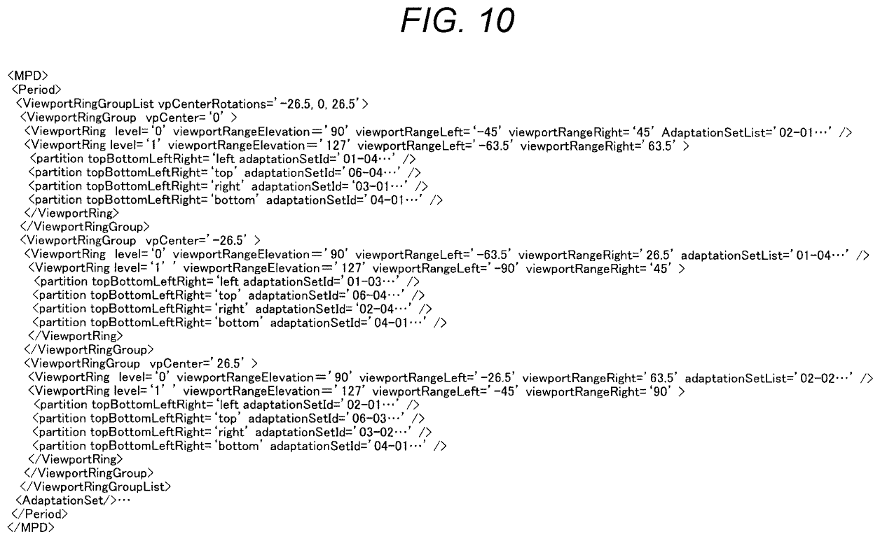

Moreover, FIG. 10 is a diagram illustrating an example of syntax in a case where a viewport ring group including viewport rings on the left side, center, and right side of two importance levels is represented by using differences. In a case where viewport rings in which the line-of-sight direction is shifted from the center of the viewport are lumped into one group, the viewport ring group metadata generation unit 121 collectively describes, in one piece of syntax, the viewport rings at positions in which the line-of-sight direction is shifted as illustrated in FIG. 10. This allows the viewport ring group metadata generation unit 121 to lump, into one group, the viewport rings in a case where the line-of-sight direction is shifted.

Next, a viewport ring group list will be described. The viewport ring group metadata generation unit 121 generates a viewport ring group list by using an MPD file acquired from the MPD generation unit 112, determined viewport rings, and viewport ring group information. Then, in the present embodiment, the viewport ring group metadata generation unit 121 stores the viewport ring group list in the MPD file. However, the storage location of the viewport ring group list is not limited to this, and the viewport ring group metadata generation unit 121 may store the viewport ring group list as an independent file without storing it in the MPD file.

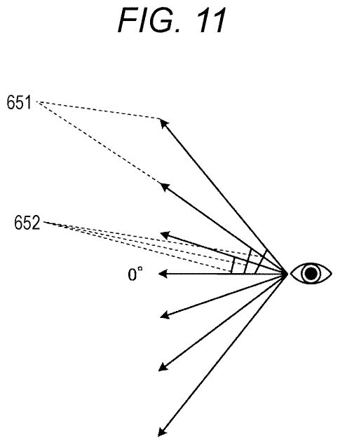

A case will be described in which boundaries of coverages of AdaptationSets included in viewport rings cannot be expressed as integral multiples of a constant angle. FIG. 11 is a diagram illustrating a case where boundaries of coverages cannot be expressed as integral multiples of a constant angle. Line-of-sight arrows 651 in FIG. 11 indicate line-of-sight directions toward centers of viewports. In a case where boundaries of coverages of AdaptationSets cannot be expressed as integral multiples of a constant angle, angles between the line-of-sight arrows 651 are different from each other. Thus, the viewport ring group metadata generation unit 121 stores, in the viewport ring group list, an angle 652 by which the line-of-sight has moved horizontally from the center of the viewport, as a viewpoint angle of each viewport ring group.

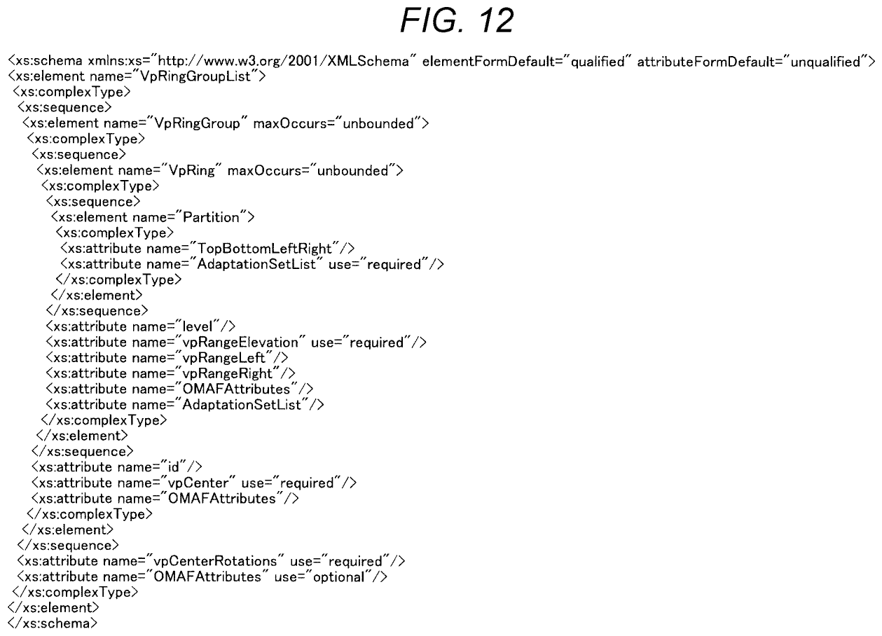

FIG. 12 is a diagram illustrating an example of syntax indicating a viewport ring group in a case where boundaries of coverages cannot be expressed as integral multiples of a constant angle. In a case where boundaries of coverages of AdaptationSets included in viewport rings cannot be expressed as integral multiples of a constant angle, the viewport ring group metadata generation unit 121 defines a viewport ring group list structure as in the syntax illustrated in FIG. 12.

In FIG. 12, vpCenterRotations represents the angle of horizontal movement from the line-of-sight direction toward the center of the viewport of each viewport ring group. Specifically, angles from the center of the viewport are expressed as −45 degrees, -26.5 degrees, 0 degrees, 26.5 degrees, and 45 degrees, for each of the left direction and the right direction. Furthermore, OMAFAttributes in the next line of vpCenterRotations is an optional parameter. In a case where there is any OMAF attribute to be used such as content coverage information (CC), projection type, or packing type, such information can be added with the use of this parameter.

Moreover, a viewport ring group list has the following viewport ring group elements. Here, a case where the center of the viewport turns in the horizontal direction, that is, a case where there is no change in elevation angle, will be described as an example. In FIG. 12, id is a globally unique viewport ring group identifier, and is represented by, for example, a uniform resource locator (URL).

vpRangeElevation is a parameter that indicates an angle to be covered symmetrically from the center of the viewport in the upward and downward direction. vpRangeLeft and vpRangeRight are parameters that indicate angles to be covered from the center of the viewport in the left direction and the right direction, respectively. OMAFAttributes in the next line of vpRangeRight is an optional parameter. In a case where there is any OMAF attribute to be used such as CC, projection type, or packing type, such information can be added with the use of this parameter. AdaptatinList in the next line is a parameter that appears in a case where the level value indicating the importance of the viewport ring is 0, in which AdaptationSetIDs included in the vpRing are listed.

Furthermore, a viewport ring group list has the following viewport ring elements. The viewport ring group metadata generation unit 121 describes a partition element in a case where the value of the level indicating importance of a viewport ring is other than 0 and the viewport ring is represented by a difference. TopBottomLeftRight designates either top, bottom, left, or right. However, in a case where there is no designation in TopBottomLeftRight, it means that the same value is collectively used for all of top, bottom, left, and right. AdaptatioList in the next line lists AdatptationSetIDs included in the corresponding partition.

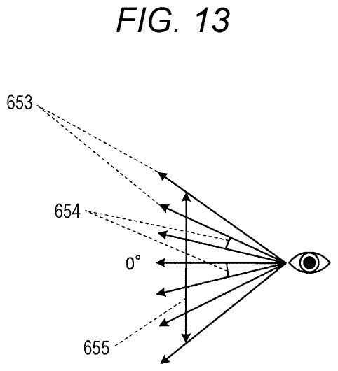

A case will be described in which boundaries of coverages of AdaptationSets included in viewport rings can be expressed as integral multiples of a constant angle. FIG. 13 is a diagram illustrating a case where boundaries of coverages can be expressed as integral multiples of a constant angle. Line-of-sight arrows 653 in FIG. 13 indicate line-of-sight directions toward centers of viewports. In a case where boundaries of coverages of AdaptationSets can be expressed as integral multiples of a constant angle, angles 654 between the line-of-sight arrows 651 are the same. Thus, the viewport ring group metadata generation unit 121 stores, in the viewport ring group list, information regarding the equal angles 654 of horizontal shift from the center of the viewport and information regarding an angle 655 that indicates a range of angles.

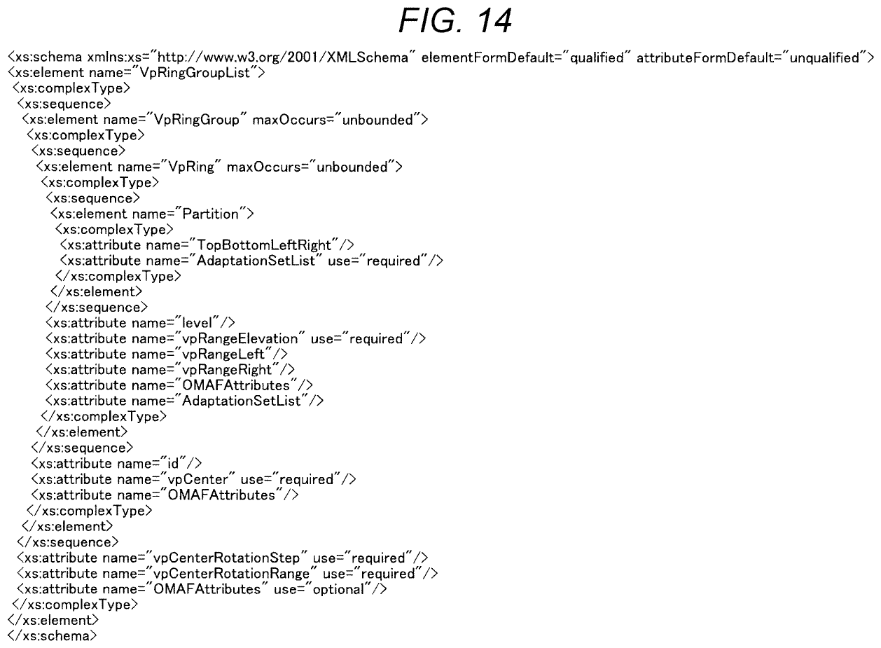

FIG. 14 is a diagram illustrating an example of syntax indicating a viewport ring group in a case where boundaries of coverages can be expressed as integral multiples of a constant angle. In a case where boundaries of coverages of AdaptationSets included in viewport rings can be expressed as integral multiples of a constant angle, the viewport ring group metadata generation unit 121 defines a viewport ring group list structure as in the syntax illustrated in FIG. 14.

In FIG. 14, vpCenterRotationStep and vpCenterRotationRange are parameters representing an angle of unit of transition and an angle of a transition range of line-of-sight directions toward centers of viewports of each viewport ring group. Specifically, the unit of transition is represented in regular intervals, such as in increments of 15 degrees or 45 degrees horizontally. Furthermore, the transition range is expressed as “from the degrees in left to the degrees in right”. Furthermore, OMAFAttributes in the next line of vpCenterRotationRange is an optional parameter. In a case where there is any OMAF attribute to be used such as CC, projection type, or packing type, such information can be added with the use of this parameter.

Moreover, a viewport ring group list has viewport ring group elements and viewport ring elements. The viewport group elements and the viewport ring elements are similar to those in a case where boundaries of coverages cannot be expressed as integral multiples of a constant angle.

The viewport ring group metadata generation unit 121 stores a viewport group list defined in a structure as described above in an MPD file, and outputs it to the edge server 2 or the client device 3.

[Configuration of Edge Server]

Returning to FIG. 1, the edge server 2 will be described. The edge server 2 has a DASH Aware Network Element (DANE) 21. The DANE 21 is a web server. The DANE 21 receives a data acquisition request from the client device 3, acquires segment data of content such as an MPD from the web server 13 of the origin server 1, and provides the segment data to the client device 3.

Furthermore, an acquisition processing unit 201 of the edge server 2 receives viewport metrics from the client device 3. Thereafter, the acquisition processing unit 201 confirms a movement of a line-of-sight on the basis of the viewport metrics, identifies data that is likely to be requested, and prefetches the segment data of the content from the web server 13. In a case where the segment data requested from the client device 3 has been read in advance by prefetch, the DANE 21 sends the segment data already retained to the client device 3.

[Configuration of Client Device]

Upon receiving a request from a user, the client device 3 sends a request to acquire content to be used to the DANE 21 of the edge server 2. Thereafter, the client device 3 acquires an MPD file corresponding to the content to be used. Then, the client device 3 analyzes the acquired MPD file, acquires segment data of a spherical image to be displayed, and outputs the segment data to a decoding unit 32.

Furthermore, a data acquisition unit 31 detects a movement of a line-of-sight, generates viewport metrics indicating a viewport, and sends the viewport metrics to the DANE 21. Moreover, the data acquisition unit 31 analyzes a viewport ring group list stored in the MPD file, and acquires the corresponding segment data. Thereafter, the data acquisition unit 31 outputs the acquired segment data to the decoding unit 32.

The decoding unit 32 receives, from the data acquisition unit 31, an input of the segment data of the content to be reproduced. Then, the decoding unit 32 decodes the acquired segment data. Thereafter, the decoding unit 32 outputs the decoded data to a view generation unit 33.

The view generation unit 33 receives an input of the decoded data from the decoding unit 32. Then, the view generation unit 33 generates an image for display by rendering three-dimensional model data and adding position information for the acquired data with the use of information regarding a viewpoint position and a line-of-sight direction, and causes a display unit 34 to display the image. The display unit 34 is a display device such as a monitor.

[Content Distribution Procedure According to First Embodiment]

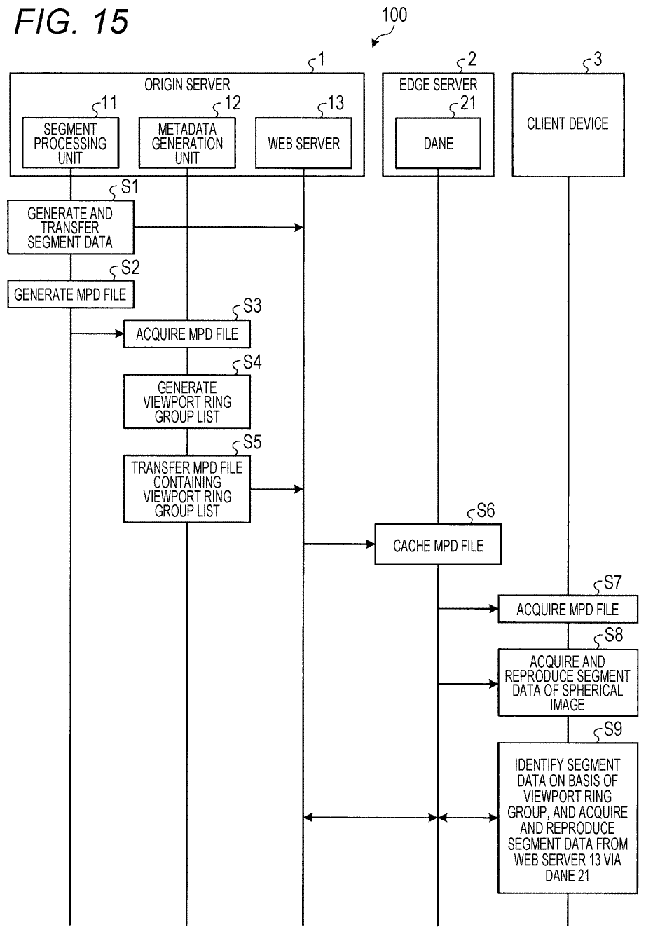

Next, with reference to FIG. 15, a flow of content distribution processing using viewport rings in the distribution system 100 according to the present embodiment will be described. FIG. 15 is a sequence diagram of the content distribution processing using viewport rings according to a first embodiment.

The segment processing unit 11 of the origin server 1 acquires original data of content and generates segment data. Then, the segment processing unit 11 transfers the generated segment data to the web server 13 (step S1).

The web server 13 acquires, stores, and retains the segment data.

Furthermore, the segment processing unit 11 generates an MPD file on the basis of the original data of the content (step S2). Furthermore, the segment processing unit 11 generates metadata such as position information and codec information, and stores the metadata in the MPD file. Then, the segment processing unit 11 outputs the generated MPD file to the metadata generation unit 12.

The metadata generation unit 12 acquires the MPD file from the segment processing unit 11 (step S3).

Then, the metadata generation unit 12 uses the number of layers of importance designated for each content, an angle of the line-of-sight direction when a viewpoint transitions, and the like to generate a viewport ring group list, with the use of adaptation sets in the MPD file (step S4).

Then, the metadata generation unit 12 stores the generated viewport ring group list in the MPD file. Thereafter, the metadata generation unit 12 transfers the MPD file containing the viewport ring group list to the web server 13 (step S5). The web server 13 stores and retains the MPD file containing the viewport ring group list.

The DANE 21 of the edge server 2 acquires and caches the MPD file containing the viewport ring group list from the web server 13 (step S6).

The client device 3 receives a content viewing request from a user, and acquires an MPD file corresponding to the content to be used from the DANE 21 (step S7). Then, the client device 3 analyzes the acquired MPD file, and identifies segment data of a spherical image that is designated content.

Thereafter, the client device 3 acquires and reproduces the segment data of the identified spherical image from the DANE 21 (step S8).

The client device 3 detects a movement of the user's viewpoint during the reproduction of the spherical image. Then, on the basis of the detected movement of the viewpoint, the client device 3 analyzes the MPD file, acquires a viewport ring group, and identifies segment data corresponding to the line-of-sight direction. Then, the client device 3 acquires and reproduces the identified segment data from the web server 13 via the DANE 21, thereby providing the user with a video of the content (step S9).

As described above, the origin server according to the present embodiment and each modified example thereof generates a viewport ring group indicating a data group corresponding to the line-of-sight direction and provides the viewport ring group to the client device. The client device uses the viewport ring group to identify a dataset to be acquired in a case where content is reproduced. In this case, the client device can identify the dataset to be acquired without analyzing a huge number of AdaptationSets, and this reduces processing load. Furthermore, it is possible to reduce the number of requests for acquiring AdaptationSets sent by the client device to the edge server, and in that respect as well, the processing load can be alleviated.

### 2. Second Embodiment

Next, a second embodiment will be described. A distribution system according to the present embodiment is also represented by the block diagram in FIG. 1. In the present embodiment, details of prefetching by an edge server 2 will be described.

An acquisition processing unit 201 of the edge server 2 receives the viewport metrics from a client device 3. Furthermore, the acquisition processing unit 201 receives, from a viewport ring group metadata generation unit 121 of an origin server 1, a file in which a viewport ring group list is stored. Then, the acquisition processing unit 201 acquires the viewport ring group list. Moreover, the acquisition processing unit 201 identifies a viewport ring group used by the client device 3 by using information regarding capabilities of the client device 3 and information regarding requests and responses that have been made. For example, the acquisition processing unit 201 determines the number of layers of importance that can be used by using the information regarding the capabilities of the client device 3 and the information regarding the requests and responses that have been made.

Thereafter, the acquisition processing unit 201 uses the viewport metrics to confirm a movement of a user's line-of-sight. Then, the acquisition processing unit 201 identifies data that is likely to be requested on the basis of the viewport ring group in accordance with the movement of the line-of-sight, and prefetches segment data of content from a web server 13.

[Content Distribution Procedure According to Second Embodiment]

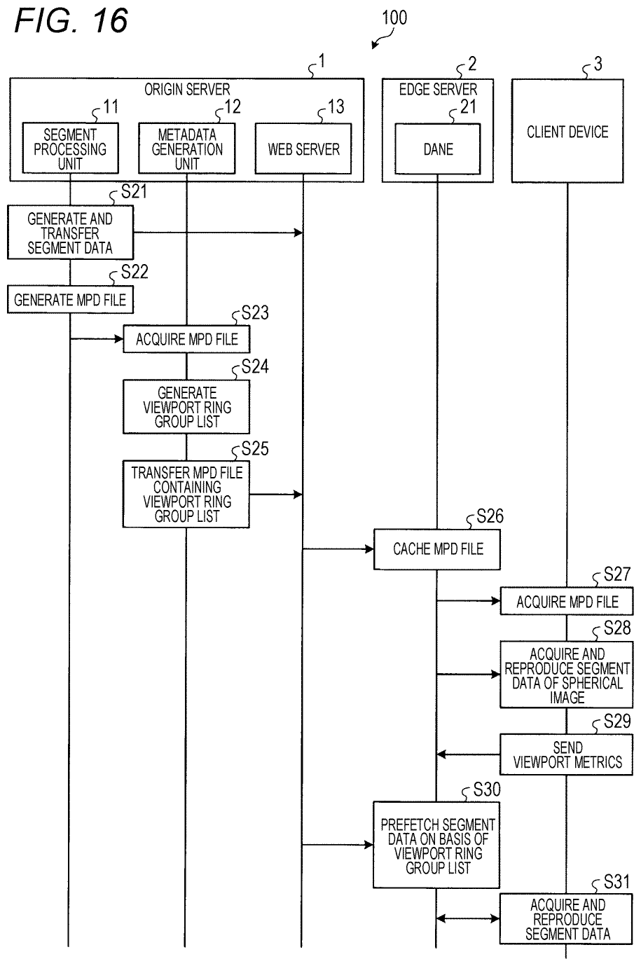

Next, with reference to FIG. 16, a flow of content distribution processing using viewport rings in a distribution system 100 according to the present embodiment will be described. FIG. 16 is a sequence diagram of the content distribution processing using viewport rings according to the second embodiment.

A segment processing unit 11 of the origin server 1 acquires original data of content and generates segment data. Then, the segment processing unit 11 transfers the generated segment data to the web server 13 (step S21). The web server 13 acquires, stores, and retains the segment data.

Furthermore, the segment processing unit 11 generates an MPD file on the basis of the original data of the content (step S22). Then, the segment processing unit 11 outputs the generated MPD file to a metadata generation unit 12.

The metadata generation unit 12 acquires the MPD file from the segment processing unit 11 (step S23).

Then, the metadata generation unit 12 uses the number of layers of importance designated for each content, an angle of the line-of-sight direction when a viewpoint transitions, and the like to generate a viewport ring group list, with the use of AdaptationSets in the MPD file (step S24).

Then, the metadata generation unit 12 stores the generated viewport ring group list in the MPD file. Furthermore, the metadata generation unit 12 generates metadata such as position information and codec information, and stores the metadata in the MPD file. Thereafter, the metadata generation unit 12 transfers the MPD file containing the viewport ring group list to the web server 13 (step S25). The web server 13 stores and retains the MPD file containing the viewport ring group list.

A DANE 21 of the edge server 2 acquires and caches the MPD file containing the viewport ring group list from the web server 13 (step S26).

The client device 3 receives a content viewing request from a user, and acquires an MPD file corresponding to the content to be used from the DANE 21 (step S27). Then, the client device 3 analyzes the acquired MPD file, and identifies segment data of a spherical image that is designated content.

Thereafter, the client device 3 acquires and reproduces the segment data of the identified spherical image from the DANE 21 (step S28).

The client device 3 detects a movement of the user's viewpoint during the reproduction of the spherical image. Then, the client device 3 generates viewport metrics indicating the line-of-sight direction on the basis of the detected viewpoint movement. Thereafter, the client device 3 sends the generated viewport metrics to the DANE 21 (step S29).

The DANE 21 receives, from the client device 3, viewport metrics in accordance with the viewpoint movement. The DANE 21 then uses the viewport metrics to confirm the movement of the viewpoint. Furthermore, the DANE 21 analyzes the MPD file to acquire a viewport ring group. Then, the DANE 21 uses the viewport ring group in accordance with the movement of the viewpoint to determine segment data to be acquired. Thereafter, the DANE 21 prefetches the determined segment group from the web server 13 (step S30).

The client device 3 identifies segment data corresponding to the user's line-of-sight direction. Then, the client device 3 acquires and reproduces the identified segment data from the DANE 21, thereby providing the user with a video of the content (step S31).

As described above, the DANE of the edge server according to the present embodiment uses a viewport ring group to identify segment data to be prefetched. In this case, the DANE can identify data corresponding to viewport metrics without analyzing a huge number of AdaptationSets in an individual MPD processed by subordinate clients. Therefore, the processing load of the DANE in prefetching can be alleviated, and prefetching can be performed promptly.

### 3. Third Embodiment

Next, a third embodiment will be described. A distribution system according to the present embodiment is also represented by the block diagram in FIG. 1. In the present embodiment, details of data acquisition by a client device will be described.

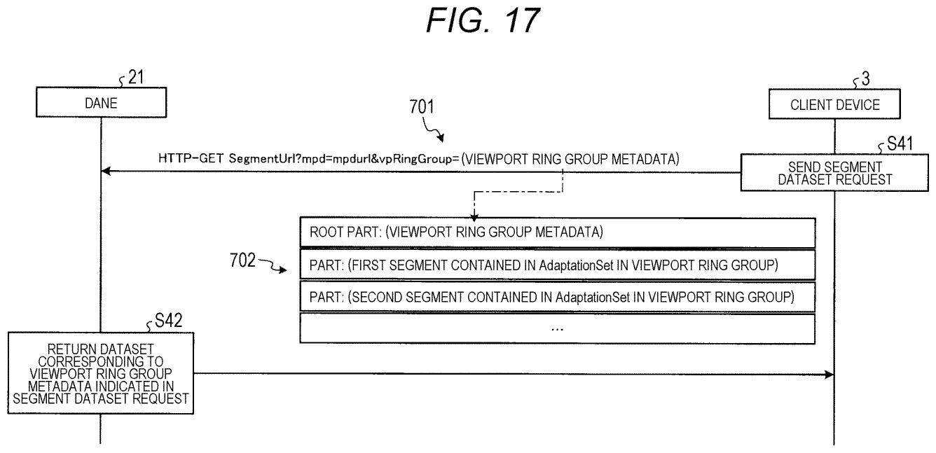

FIG. 17 is a sequence diagram illustrating segment data acquisition processing according to the third embodiment. A data acquisition unit 31 of a client device 3 according to the present embodiment sends, to a DANE 21, a segment dataset request, which is a Hypertext Transfer Protocol (HTTP) request that specifies a segment data group to be acquired, to request for a dataset to be reproduced (step S41).

For example, the data acquisition unit 31 sends, to the DANE 21, the segment data request indicated by syntax 701 in FIG. 17. SegmentUrl in the Syntax 701 stores a URL of one segment contained in an AdaptationSet in a viewport ring group. Furthermore, mpdurl in the syntax 701 stores a URL of an MPD to be used. Moreover, the syntax 701 stores viewport ring group metadata designated by the client device 3. In this way, in a segment request at a specific time, the data acquisition unit 31 designates a viewport ring group as a URL parameter for identifying segment dataset to be acquired. Thus, the data acquisition unit 31 instructs the DANE 21 to collectively return, as a multipart response, a segment group in an AdaptationSet group designated by a viewport group aligned on a time axis with a segment designated in the segment dataset request.

The DANE 21 receives, from the data acquisition unit 31 of the client device 3, the segment dataset request that specifies a segment data group to be acquired. The DANE 21 then returns a dataset corresponding to the viewport ring group metadata designated in the segment dataset request (step S42), and processes a request-response transaction.

For example, the DANE 21 sends a multipart response 702 to the client device 3. The DANE 21 stores, in a root part of the multipart response 702, the viewport ring group metadata designated in the segment dataset request. Moreover, the DANE 21 stores, in a corresponding part of the multipart response 702, each segment contained in an AdaptationSet in the viewport ring group.

In this case, the entire multipart response 702 corresponds to a unit of atomic response. Thus, in a case where all of the multipart response 702 is normally received, the client device 3 can buffer and make it available to an application. By receiving this multipart response, the client device 3 can acquire all data at a time in one transaction.

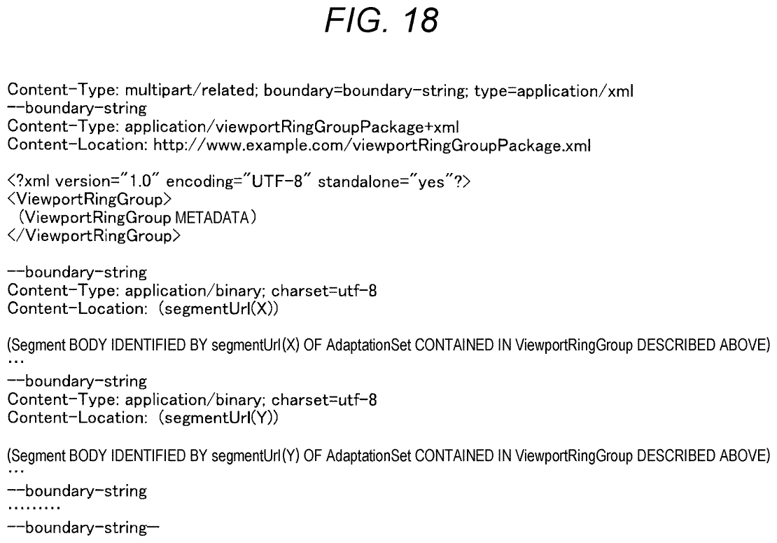

FIG. 18 is a diagram illustrating an example of a response to a segment dataset request according to the third embodiment. The DANE 21 generates a multipart response as illustrated in FIG. 18. The DANE 21 registers a segment body for each part of a multipart in a response body of the multipart response. Moreover, the DANE 21 copies information regarding a viewport ring group designated in the segment dataset request to the root part so that it is possible to determine an AdaptationSet in which data of the segment body registered for each part is included.

As described above, the client device according to the present embodiment designates a viewport ring group and makes a request to acquire segment data. Then, the DANE collectively sends, to the client device, a segment group of AdaptationSets designated by the designated viewport ring group. Thus, it is possible to send and receive all data at a time in one transaction, and simplify communication between the client device and the DANE.

### 3.1 Modified Example (1) of Third Embodiment

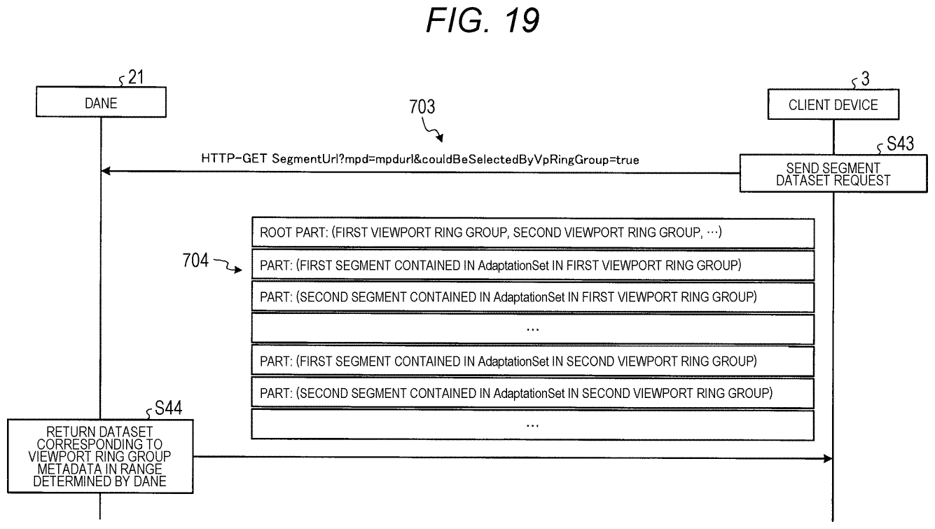

The data acquisition unit 31 of the client device 3 according to the present modified example sends a segment dataset request to allow the DANE 21 side to determine a segment data group to be sent. FIG. 19 is a sequence diagram illustrating segment data acquisition processing according to a modified example (1) of the third embodiment.

The data acquisition unit 31 sends, to the DANE 21, a segment dataset request, which is an HTTP request indicated by syntax 703 (step S43). SegmentUrl in the syntax 703 stores a URL of one segment contained in an AdaptationSet in a viewport ring group. Furthermore, mpdurl in the syntax 703 stores a URL of an MPD to be used.

Moreover, the data acquisition unit 31 stores ture, which is a flag indicating that segment data may be collectively returned as a response on the basis of a selection criterion on the DANE 21 side, as a URL parameter for identifying segment dataset to be acquired in the syntax 703.

The DANE 21 receives the segment dataset request. Then, the DANE 21 determines a target viewport ring group. Then, the DANE 21 returns, to the client device 3, a segment dataset corresponding to viewport ring group metadata in a determined range (step S44), and processes a request-response transaction.

The DANE 21 determines, for example, viewport ring groups to be selected from viewport ring groups aligned on the time axis with the requested segment data. Then, the DANE 21 collectively sends, as a multipart response 704, AdaptationSet groups of the selected viewport ring groups to the client device 3.

The DANE 21 lists the selected viewport ring groups in a root part in the multipart response 704. Moreover, the DANE 21 sequentially stores segments included in the AdaptationSets of each of the listed viewport groups for each part of the multipart response 704.

In this case, the entire multipart response 704 corresponds to a unit of atomic response. Thus, in a case where all of the multipart response 704 is normally received, the client device 3 can buffer and make it available to an application.

### 3.2 Modified Example (2) of Third Embodiment

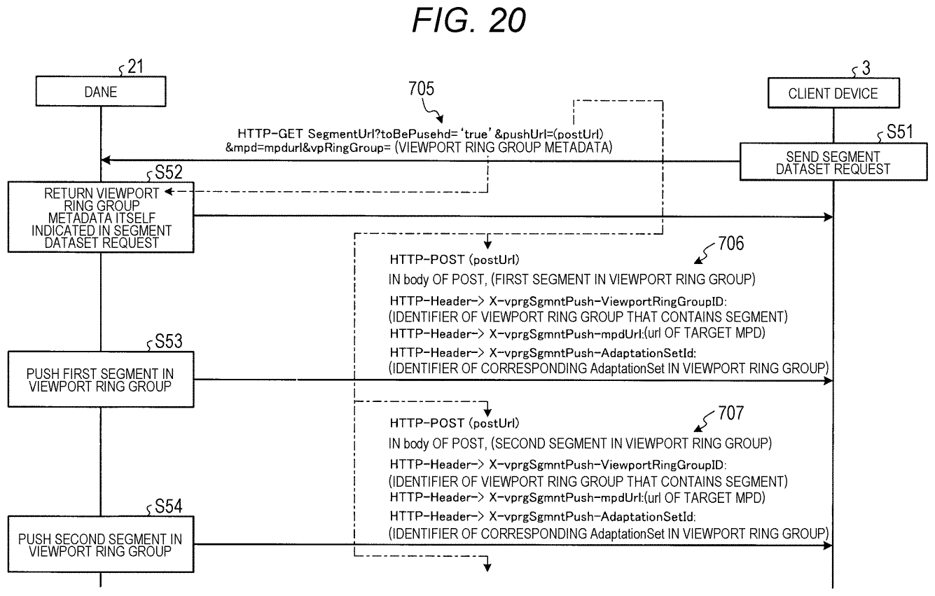

FIG. 20 is a sequence diagram illustrating segment data acquisition processing according to a modified example (2) of the third embodiment. The data acquisition unit 31 of the client device 3 according to the present modified example sends a segment dataset request, which is an HTTP request indicated by syntax 705, to the DANE 21 (step S51).

SegmentUrl in the syntax 705 stores a URL of one segment contained in an AdaptationSet in a viewport ring group. Furthermore, pushUrl in the syntax 705 stores a push destination address. In this case, the push destination address is an address of the client device 3. Moreover, in a segment request at a specific time, the data acquisition unit 31 designates a viewport ring group as a URL parameter for identifying segment dataset to be acquired. Thus, the client device 3 instructs the DANE 21 to return, by push transfer, an AdaptationSet group designated by the viewport ring group aligned on the time axis with a segment designated in the segment dataset request.

When the DANE 21 receives the segment dataset request from the client device 3, the DANE 21 returns, to the client device 3, viewport ring group metadata itself designated in the segment dataset request as a first push response (step S52), and processes a request-response transaction.

Thereafter, the DANE 21 uses an HTTP POST 706 to push a first segment in the designated viewport ring group to the client device 3 as a subsequent push response (step S53). A body of the HTTP POST 706 stores the first segment in the viewport ring group.

The DANE 21 sends the HTTP POST 706 to postUrl designated in the segment dataset request. In a header of the HTTP POST 706, an identifier of the viewport ring group that contains the segment to be stored, a URL of a target MPD, and an identifier of an AdaptationSet in the viewport ring group are registered.

For the purpose of indicating which segment is stored in an individual HTTP POST body to be sent to the client device 3, the DANE 21 introduces extension HTTP headers “X-vprgSgmntPush-mdpUrl” and “X-vprgSgmntPush-AdaptationSetID” for an individual request, each of which stores the URL of the target MPD and the identifier of the target AdaptationSet. An address of the client device 3 to which the HTTP POST is sent is described in <pushAddress> of the syntax 705 as follows. For example, <pushAddress> is described as pushUrl=“http address thrown for HTTP POST”, or pushDescriptionUrl=“address such as Session Description Protocol (SDP)”. In a case where pushDescriptionUrl is used, a session description acquired by this URL is SDP (/S-TSID) of FLUTE (/ROUTE).

In this case, the HTTP POST 706 corresponds to a unit of atomic response. Thus, when the HTTP POST 706 is normally received, the client device 3 can buffer and make it available to an application.

Next, the DANE 21 uses an HTTP POST 707 to push a second segment in the designated viewport ring group to the client device 3 as a subsequent push response (step S54). The HTTP POST 707 is described in a structure similar to that of the HTTP POST 706.

The HTTP POST 707 is also a unit of atomic response, and when the HTTP POST 707 is normally received, the client device 3 can buffer and make it available to an application.

In a similar manner, the DANE 21 repeats sending of a segment dataset response until all the segments included in the designated viewport ring group are sent.

In this case, since the client device 3 can use the segment data when one segment has been sent, the time until reproduction can be shortened.

### 3.3 Modified Example (3) of Third Embodiment

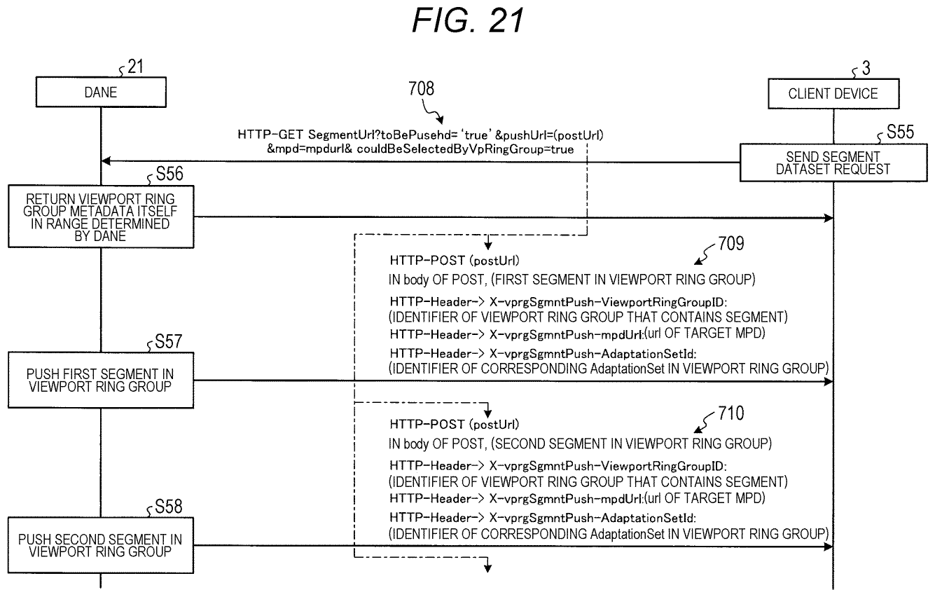

FIG. 21 is a sequence diagram illustrating segment data acquisition processing according to a modified example (3) of the third embodiment. The data acquisition unit 31 of the client device 3 according to the present modified example sends a segment dataset request indicated by syntax 708 to the DANE 21 (step S55).

SegmentUrl in the syntax 708 stores a URL of one segment contained in an AdaptationSet in a viewport ring group. Furthermore, pushUrl in the syntax 708 stores a push destination address. In this case, the push destination address is an address of the client device 3.

Moreover, the data acquisition unit 31 stores ture, which is a flag indicating that segment data may be collectively returned as a response on the basis of a selection criterion on the DANE 21 side, as a URL parameter for identifying segment dataset to be acquired in the syntax 708.

The DANE 21 receives the segment dataset request. Then, the DANE 21 determines a viewport ring group to use. For example, the DANE 21 determines viewport ring groups to be selected from viewport ring groups aligned on the time axis with the requested segment data. Then, the DANE 21 returns, to the client device 3, viewport ring group metadata itself in a determined range as a first push response (step S56), and processes a request-response transaction.

Thereafter, the DANE 21 uses an HTTP POST 709 to push, to the client device 3, a first segment in one of the selected viewport ring groups as a subsequent push response (step S57). A body of the HTTP POST 709 stores the first segment in the one of the selected viewport ring groups.

The DANE 21 sends the HTTP POST 709 to postUrl designated in the segment dataset request. In a header of the HTTP POST 709, an identifier of the viewport ring group that contains the segment to be stored, a URL of a target MPD, and an identifier of an AdaptationSet in the viewport ring group are registered.

For the purpose of indicating which segment is stored in an individual HTTP POST body to be sent to the client device 3, the DANE 21 introduces extension HTTP headers “X-vprgSgmntPush-mdpUrl” and “X-vprgSgmntPush-AdaptationSetID” for an individual request, each of which stores the URL of the target MPD and the identifier of the target AdaptationSet. The address of the client device 3 to which the HTTP POST is sent is described in <pushAddress> of the syntax 708 as follows. For example, <pushAddress> is described as pushUrl=“http address thrown for HTTP POST”, or pushDescriptionUrl=“address such as Session Description Protocol (SDP)”. In a case where pushDescriptionUrl is used, a session description acquired by this URL is SDP (/S-TSID) of FLUTE (/ROUTE).

In this case, the HTTP POST 709 corresponds to a unit of atomic response. Thus, when the HTTP POST 709 is normally received, the client device 3 can buffer and make it available to an application.

Next, the DANE 21 uses an HTTP POST 710 to push, to the client device 3, a second segment in the one of the selected viewport ring groups as a subsequent push response (step S58). The HTTP POST 710 is described in a structure similar to that of the HTTP POST 709.

The HTTP POST 710 is also a unit of atomic response, and when the HTTP POST 710 is normally received, the client device 3 can buffer and make it available to an application.

In a similar manner, the DANE 21 repeats sending of a segment dataset response until all the segments included in each of the selected viewport ring groups are sent.

In this case, since the client device 3 can use the segment data when one segment has been sent, the time until reproduction can be shortened.

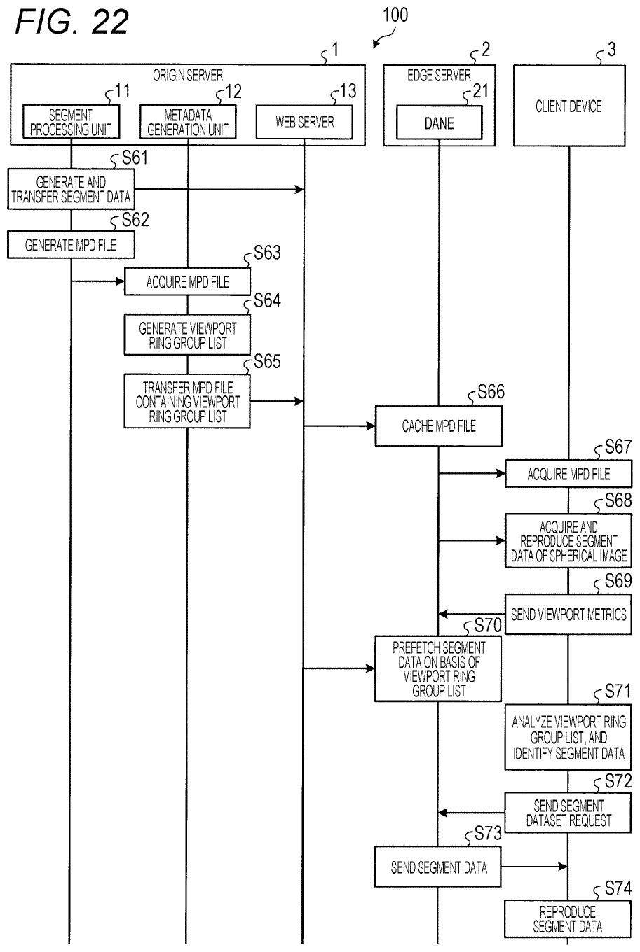

Next, with reference to FIG. 22, a flow of content distribution processing using viewport rings in a distribution system 100 according to the third embodiment and each modified example will be described. FIG. 22 is a sequence diagram of content distribution processing using viewport rings according to the third embodiment and each modified example of the third embodiment.

A segment processing unit 11 of an origin server 1 acquires original data of content and generates segment data. Then, the segment processing unit 11 transfers the generated segment data to a web server 13 (step S61). The web server 13 acquires, stores, and retains the segment data.

Furthermore, the segment processing unit 11 generates an MPD file on the basis of the original data of the content (step S62). Furthermore, the segment processing unit 11 generates metadata such as position information and codec information, and stores the metadata in the MPD file. Then, the segment processing unit 11 outputs the generated MPD file to a metadata generation unit 12.

The metadata generation unit 12 acquires the MPD file from the segment processing unit 11 (step S63).

Then, the metadata generation unit 12 uses the number of layers of importance designated for each content, an angle of the line-of-sight direction when a viewpoint transitions, and the like to generate a viewport ring group list, with the use of AdaptationSets in the MPD file (step S64).

Then, the metadata generation unit 12 stores the generated viewport ring group list in the MPD file. Thereafter, the metadata generation unit 12 transfers the MPD file containing the viewport ring group list to the web server 13 (step S65). The web server 13 stores and retains the MPD file containing the viewport ring group list.

The DANE 21 of an edge server 2 acquires and caches the MPD file containing the viewport ring group list from the web server 13 (step S66).

The client device 3 receives a content viewing request from a user, and acquires an MPD file corresponding to the content to be used from the DANE 21 (step S67). Then, the client device 3 analyzes the acquired MPD file, and identifies segment data of a spherical image that is designated content.

Thereafter, the client device 3 acquires and reproduces the segment data of the identified spherical image from the DANE 21 (step S68).

The client device 3 detects a movement of the user's viewpoint during the reproduction of the spherical image. Then, the client device 3 generates viewport metrics indicating the line-of-sight direction on the basis of the detected viewpoint movement. Thereafter, the client device 3 sends the generated viewport metrics to the DANE 21 (step S69).

The DANE 21 receives, from the client device 3, viewport metrics in accordance with the viewpoint movement. The DANE 21 then uses the viewport metrics to confirm the movement of the viewpoint. Furthermore, the DANE 21 analyzes the MPD file to acquire a viewport ring group. Then, the DANE 21 uses the viewport ring group in accordance with the movement of the viewpoint to determine segment data to be acquired. Thereafter, the DANE 21 prefetches the determined segment group from the web server 13 (step S70).

The client device 3 analyzes the viewport ring group list, and uses the analysis result to identify segment data corresponding to the user's line-of-sight direction (step S71).

Next, the client device 3 uses the viewport ring group corresponding to the identified segment data to generate a segment dataset request, and sends the generated segment dataset request to the DANE 21 (step S72). For this segment dataset request, each segment dataset request described in the third embodiment or each modified example is used.

The DANE 21 receives the segment dataset request from the client device 3. Then, the DANE 21 sends segment data identified from the segment dataset request to the client device 3 (step S73). At this time, the DANE 21 returns the response described in the third embodiment or each modified example.

The client device 3 acquires and reproduces the segment data from the DANE 21, thereby providing the user with a video of the content (step S74).

Although the embodiments of the present disclosure have been described above, the technical scope of the present disclosure is not limited to the above-described embodiments as they are, and a variety of changes can be made without departing from the gist of the present disclosure. Furthermore, components in different embodiments and modified examples may be combined as appropriate.

Note that the effects described herein are merely illustrative and are not intended to be restrictive, and other effects may be obtained.

Note that the present technology may also have the following configurations.

(1) An information processing apparatus including:

a media presentation description (MPD) generation unit that generates an MPD of an image divided by unit area; and

a metadata generation unit that generates each of viewport rings by, on the basis of the MPD generated by the MPD generation unit and viewport information indicating a line-of-sight direction for each of priorities determined in advance corresponding to a center of a reference line-of-sight direction, grouping AdaptationSets corresponding to a predetermined area of each of the priorities designated by each piece of the viewport information and grouping AdaptationSets corresponding to each surrounding area of the predetermined area determined by the unit area, generates a viewport ring group by grouping the viewport rings on the basis of the center of the reference line-of-sight direction, and generates a viewport ring group list by listing information regarding a plurality of the viewport ring groups.

(2) The information processing apparatus according to note (1), in which the metadata generation unit transmits the viewport ring group list to an edge server via a first network.

(3) The information processing apparatus according to note (1) or (2), in which in a case where angles, from the center of the reference line-of-sight direction, of boundaries of coverages of AdaptationSets designated by each of the viewport rings belonging to a predetermined viewport ring group are not integral multiples of a constant angle, the metadata generation unit stores, in the viewport ring group list, a viewpoint angle of a center of a line-of-sight direction in each of the viewport rings in a horizontal direction from the center of the reference line-of-sight direction.

(4) The information processing apparatus according to any one of notes (1) to (3), in which in a case where angles, from the center of the reference line-of-sight direction, of boundaries of coverages of AdaptationSets designated by the viewport rings are expressed as integral multiples of a constant angle, the metadata generation unit stores, in the viewport ring group list, information regarding the constant angle and information regarding a range of the line-of-sight direction in each of the viewport rings.

(5) An information processing method that causes a computer to execute processing including:

generating an MPD of an image divided by unit area;

generating each of viewport rings by, on the basis of the MPD generated by the MPD generation unit and viewport information indicating a line-of-sight direction for each of priorities determined in advance corresponding to a center of a reference line-of-sight direction, grouping AdaptationSets corresponding to a predetermined area of each of the priorities designated by each piece of the viewport information and grouping AdaptationSets corresponding to each surrounding area of the predetermined area determined by the unit area;

generating viewport ring group by grouping the viewport rings on the basis of the center of the reference line-of-sight direction; and

generating a viewport ring group list by listing information regarding a plurality of the viewport ring groups.

(6) An information processing apparatus including: an acquisition processing unit that receives a viewport ring group list that lists information regarding a plurality of viewport ring groups in which, on the basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on the basis of the center of the reference line-of-sight direction, and acquires client viewport information from a client device via a second network and then acquires in advance segment data on the basis of the viewport ring group list and the client viewport information.

(7) An information processing method that causes a computer to execute processing including:

receiving a viewport ring group list that lists information regarding a plurality of viewport ring groups in which, on the basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on the basis of the center of the reference line-of-sight direction; and

acquiring client viewport information from a client device via a second network and then acquiring in advance segment data on the basis of the viewport ring group list and the client viewport information.

(8) A reproduction processing device including: a data acquisition unit that receives from an edge server via a second network a viewport ring group list that lists, as viewport ring group information, information regarding each one of a plurality of viewport ring groups in which, on the basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on the basis of the center of the reference line-of-sight direction, and sends to the edge server, on the basis of the viewport ring group list, an HTTP request that includes multipart response request information for requesting to configure and return, as a multipart response, a plurality of pieces of segment data constituting a plurality of grouped AdaptationSets designated by the viewport ring group list.

(9) The reproduction processing device according to note (8), in which the multipart response request information includes information regarding whether or not to collectively return the segment data on the basis of a selection criterion of the edge server.

(10) The reproduction processing device according to note (9), in which in a case where the segment data is not to be collectively returned on the basis of the selection criterion of the edge server, the data acquisition unit generates the HTTP request having a new request URL in which an additional parameter indicating the viewport ring group information of a selected one of the viewport ring groups is added to information regarding access to the segment data.

(11) The reproduction processing device according to note (10), in which in the multipart response from the edge server to the HTTP request, the viewport ring group information contained in the HTTP request is stored in a root part, and segment data of each AdaptationSet designated by the viewport ring group selected by the data acquisition unit is stored in a part other than the root part.

(12) The reproduction processing device according to note (9), in which in a case where the segment data is to be collectively returned on the basis of the selection criterion of the edge server, the data acquisition unit generates the HTTP request having a new request URL in which an additional parameter indicating information for allowing the segment data to be collectively returned on the basis of the selection criterion of the edge server is added to information regarding access to the segment data.

(13) The reproduction processing device according to note (12), in which in the multipart response from the edge server to the HTTP request, the viewport ring group information of the viewport ring group selected by the edge server is stored in a root part, and segment data of each AdaptationSet designated by the viewport ring group selected by the edge server is stored in a part other than the root part.

(14) A reproduction processing method that causes a computer to execute processing including:

receiving from an edge server via a second network a viewport ring group list that lists, as viewport ring group information, information regarding each one of a plurality of viewport ring groups in which, on the basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on the basis of the center of the reference line-of-sight direction; and

sending to the edge server, on the basis of the viewport ring group list, an HTTP request that includes multipart response request information for requesting to configure and return, as a multipart response, a plurality of pieces of segment data constituting a plurality of grouped AdaptationSets designated by the viewport ring group list.

(15) A reproduction processing device including: a data acquisition unit that receives from an edge server via a second network a viewport ring group list that lists, as viewport ring group information, information regarding each one of a plurality of viewport ring groups in which, on the basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on the basis of the center of the reference line-of-sight direction, and sends to the edge server, on the basis of the viewport ring group list, an HTTP request that includes push response request information for requesting to return a plurality of pieces of segment data constituting a plurality of AdaptationSets designated by the viewport ring group information, as a push response for each of the pieces of segment data.

(16) The reproduction processing device according to note (15), in which the multipart response request information includes information regarding whether or not to collectively return the segment data on the basis of a selection criterion of the edge server.

(17) The reproduction processing device according to note (16), in which in a case where the segment data is not to be collectively returned on the basis of the selection criterion of the edge server, the data acquisition unit generates the HTTP request having a new request URL in which additional parameters indicating information for allowing push sending, a push address, and the viewport ring group information corresponding to a selected one of the viewport ring groups are added to information regarding access to the segment data.

(18) The reproduction processing device according to note (17), in which the viewport ring group information included in the HTTP request is stored in the first push response from the edge server to the HTTP request, and segment data of each AdaptationSet designated by the viewport ring group selected by the data acquisition unit is stored in a corresponding one of the subsequent push responses.

(19) The reproduction processing device according to note (15), in which in a case where the segment data is to be collectively returned on the basis of a selection criterion of the edge server, the data acquisition unit generates the HTTP request having a new request URL in which, to information regarding access to the segment data, additional parameters indicating information for allowing push sending, a push address, and information for allowing the segment data to be collectively returned on the basis of the selection criterion of the edge server are added to information regarding access to the segment data.

(20) The reproduction processing device according to note (19), in which the viewport ring group information of the viewport ring group selected by the edge server is stored in the first push response from the edge server to the HTTP request, and segment data of each AdaptationSet designated by the viewport ring group selected by the edge server is stored in a corresponding one of the subsequent push responses.

(21) A reproduction processing method that causes a computer to execute processing including:

receiving from an edge server via a second network a viewport ring group list that lists, as viewport ring group information, information regarding each one of a plurality of viewport ring groups in which, on the basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on the basis of the center of the reference line-of-sight direction; and sending to the edge server, on the basis of the viewport ring group list, an HTTP request that includes push response request information for requesting to return a plurality of pieces of segment data constituting a plurality of AdaptationSets designated by the viewport ring group information, as a push response for each of the pieces of segment data.

### REFERENCE SIGNS LIST

1 Origin server
2 Edge server
3 Client device
11 Segment processing unit
12 Metadata generation unit
13 Web server
21 DANE
31 Data acquisition unit
32 Decoding unit
33 View generation unit
34 Display unit
100 Distribution system
111 Data generation unit
112 MPD generation unit
121 Viewport ring group metadata generation unit
201 Acquisition processing unit

1. An information processing apparatus comprising:
a media presentation description (MPD) generation unit that generates an MPD for an image divided by unit area; and
a metadata generation unit that generates each of viewport rings by, on a basis of the MPD generated by the MPD generation unit and viewport information indicating a line-of-sight direction for each of priorities determined in advance corresponding to a center of a reference line-of-sight direction, grouping AdaptationSets corresponding to a predetermined area of each of the priorities designated by each piece of the viewport information and grouping AdaptationSets corresponding to each surrounding area of the predetermined area determined by the unit area, generates a viewport ring group by grouping the viewport rings on a basis of the center of the reference line-of-sight direction, and generates a viewport ring group list by listing information regarding a plurality of the viewport ring groups.

2. The information processing apparatus according to claim 1, wherein the metadata generation unit transmits the viewport ring group list to an edge server via a first network.

3. The information processing apparatus according to claim 1, wherein in a case where angles, from the center of the reference line-of-sight direction, of boundaries of coverages of AdaptationSets designated by each of the viewport rings belonging to a predetermined viewport ring group are not integral multiples of a constant angle, the metadata generation unit stores, in the viewport ring group list, a viewpoint angle of a center of a line-of-sight direction in each of the viewport rings in a horizontal direction from the center of the reference line-of-sight direction.

4. The information processing apparatus according to claim 1, wherein in a case where angles, from the center of the reference line-of-sight direction, of boundaries of coverages of AdaptationSets designated by the viewport rings are expressed as integral multiples of a constant angle, the metadata generation unit stores, in the viewport ring group list, information regarding the constant angle and information regarding a range of the line-of-sight direction in each of the viewport rings.

5. An information processing method that causes a computer to execute processing comprising:
generating an MPD for an image divided by unit area;
generating each of viewport rings by, on a basis of the generated MPD and viewport information indicating a line-of-sight direction for each of priorities determined in advance corresponding to a center of a reference line-of-sight direction, grouping AdaptationSets corresponding to a predetermined area of each of the priorities designated by each piece of the viewport information and grouping AdaptationSets corresponding to each surrounding area of the predetermined area determined by the unit area;
generating viewport ring group by grouping the viewport rings on a basis of the center of the reference line-of-sight direction; and
generating a viewport ring group list by listing information regarding a plurality of the viewport ring groups.

6. An information processing apparatus comprising: an acquisition processing unit that receives a viewport ring group list that lists information regarding a plurality of viewport ring groups in which, on a basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on a basis of the center of the reference line-of-sight direction, and acquires client viewport information from a client device via a second network and then acquires in advance segment data on a basis of the viewport ring group list and the client viewport information.

7. An information processing method that causes a computer to execute processing comprising:
receiving a viewport ring group list that lists information regarding a plurality of viewport ring groups in which, on a basis of an MPD for an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on a basis of the center of the reference line-of-sight direction; and
acquiring client viewport information from a client device via a second network and then acquiring in advance segment data on a basis of the viewport ring group list and the client viewport information.

8. A reproduction processing device comprising: a data acquisition unit that receives from an edge server via a second network a viewport ring group list that lists, as viewport ring group information, information regarding each one of a plurality of viewport ring groups in which, on a basis of an MPD for an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on a basis of the center of the reference line-of-sight direction, and sends to the edge server, on a basis of the viewport ring group list, an HTTP request that includes multipart response request information for requesting to configure and return, as a multipart response, a plurality of pieces of segment data constituting a plurality of grouped AdaptationSets designated by the viewport ring group list.

9. The reproduction processing device according to claim 8, wherein the multipart response request information includes information regarding whether or not to collectively return the segment data on a basis of a selection criterion of the edge server.

10. The reproduction processing device according to claim 9, wherein in a case where the segment data is not to be collectively returned on a basis of the selection criterion of the edge server, the data acquisition unit generates the HTTP request having a new request URL in which an additional parameter indicating the viewport ring group information of a selected one of the viewport ring groups is added to information regarding access to the segment data.

11. The reproduction processing device according to claim 10, wherein in the multipart response from the edge server to the HTTP request, the viewport ring group information contained in the HTTP request is stored in a root part, and segment data of each AdaptationSet designated by the viewport ring group selected by the data acquisition unit is stored in a part other than the root part.

12. The reproduction processing device according to claim 9, wherein in a case where the segment data is to be collectively returned on a basis of the selection criterion of the edge server, the data acquisition unit generates the HTTP request having a new request URL in which an additional parameter indicating information for allowing the segment data to be collectively returned on a basis of the selection criterion of the edge server is added to information regarding access to the segment data.

13. The reproduction processing device according to claim 12, wherein in the multipart response from the edge server to the HTTP request, the viewport ring group information of the viewport ring group selected by the edge server is stored in a root part, and segment data of each AdaptationSet designated by the viewport ring group selected by the edge server is stored in a part other than the root part.

14. A reproduction processing method that causes a computer to execute processing comprising:
receiving from an edge server via a second network a viewport ring group list that lists, as viewport ring group information, information regarding each one of a plurality of viewport ring groups in which, on a basis of an MPD for an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on a basis of the center of the reference line-of-sight direction; and
sending to the edge server, on a basis of the viewport ring group list, an HTTP request that includes multipart response request information for requesting to configure and return, as a multipart response, a plurality of pieces of segment data constituting a plurality of grouped AdaptationSets designated by the viewport ring group list.

15. A reproduction processing device comprising: a data acquisition unit that receives from an edge server via a second network a viewport ring group list that lists, as viewport ring group information, information regarding each one of a plurality of viewport ring groups in which, on a basis of an MPD for an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on a basis of the center of the reference line-of-sight direction, and sends to the edge server, on a basis of the viewport ring group list, an HTTP request that includes push response request information for requesting to return a plurality of pieces of segment data constituting a plurality of AdaptationSets designated by the viewport ring group information, as a push response for each of the pieces of segment data.

16. The reproduction processing device according to claim 15, wherein the push response request information includes information regarding whether or not to collectively return the segment data on a basis of a selection criterion of the edge server.

17. The reproduction processing device according to claim 16, wherein in a case where the segment data is not to be collectively returned on a basis of the selection criterion of the edge server, the data acquisition unit generates the HTTP request having a new request URL in which additional parameters indicating information for allowing push sending, a push address, and the viewport ring group information corresponding to a selected one of the viewport ring groups are added to information regarding access to the segment data.

18. The reproduction processing device according to claim 17, wherein the viewport ring group information included in the HTTP request is stored in the first push response from the edge server to the HTTP request, and segment data of each AdaptationSet designated by the viewport ring group selected by the data acquisition unit is stored in a corresponding one of the subsequent push responses.

19. The reproduction processing device according to claim 15, wherein in a case where the segment data is to be collectively returned on a basis of a selection criterion of the edge server, the data acquisition unit generates the HTTP request having a new request URL in which, to information regarding access to the segment data, additional parameters indicating information for allowing push sending, a push address, and information for allowing the segment data to be collectively returned on a basis of the selection criterion of the edge server are added to information regarding access to the segment data.

20. The reproduction processing device according to claim 19, wherein the viewport ring group information of the viewport ring group selected by the edge server is stored in the first push response from the edge server to the HTTP request, and segment data of each AdaptationSet designated by the viewport ring group selected by the edge server is stored in a corresponding one of the subsequent push responses.

21. A reproduction processing method that causes a computer to execute processing comprising:
receiving from an edge server via a second network a viewport ring group list that lists, as viewport ring group information, information regarding each one of a plurality of viewport ring groups in which, on a basis of an MPD of an image divided by unit area and viewport information indicating a line-of-sight direction for each of priorities determined in advance corresponding to a center of a reference line-of-sight direction, viewport rings generated by grouping AdaptationSets corresponding to a predetermined area of each of the priorities designated by each piece of the viewport information and grouping AdaptationSets corresponding to each surrounding area of the predetermined area determined by the unit area are grouped on a basis of the center of the reference line-of-sight direction; and
sending to the edge server, on a basis of the viewport ring group list, an HTTP request that includes push response request information for requesting to return a plurality of pieces of segment data constituting a plurality of AdaptationSets designated by the viewport ring group information, as a push response for each of the pieces of segment data.
